(19) United States
(12) Patent Application Publication
(10) Pub. No.: US 2026/0032746 A1
(43) Pub. Date: Jan. 29, 2026

(54) COMMUNICATION DEVICE AND COMMUNICATION METHOD

(71) Applicant: NTT DOCOMO, INC., Tokyo (JP)

(72) Inventors: Daisuke KURITA, Tokyo (JP); Hiroki HARADA, Tokyo (JP); Weiqi SUN, Beijing (CN); Jing WANG, Beijing (CN); Lan CHEN, Beijing (CN)

(73) Assignee: NTT DOCOMO, INC., Tokyo (JP)

(21) Appl. No.: 18/995,234

(22) PCT Filed: Jul. 27, 2022
(86) PCT No.: PCT/JP2022/029006

§ 371 Date: Jan. 16, 2025

(51) Int. Cl. H04W 76/15; H04W 8/22; H04W 72/20

(52) U.S. Cl. CPC H04W 76/15; H04W 8/22; H04W 72/20

(57) ABSTRACT

A communication device comprising: a control unit that, on the basis of whether simultaneous operations are supported, said simultaneous operations being a transmission operation or a reception operation on a first link between a base station and the communication device, and a transmission operation or a reception operation on a second link between the base station and the communication device, said second link being used for forwarding between the base station and a terminal, controls the transmission operation or reception operation on the second link; and a communication unit that performs signal transmission or reception on the second link in accordance with the control of the control unit.

### TECHNICAL FIELD

The present disclosure relates to a communication apparatus and a communication method.

### BACKGROUND ART

In Universal Mobile Telecommunication System (UMTS) networks, Long Term Evolution (LTE) has been specified with the aim of achieving higher data rates, lower latency, and other improvements. Future systems of LTE have also been studied for achieving a broader bandwidth and a higher speed based on LTE. Successor systems to LTE include, for example, systems referred to as LTE-Advanced (LTE-A), Future Radio Access (FRA), 5th generation mobile communication system (5G), 5G plus (5G+), Radio Access Technology (New-RAT), New Radio (NR), and the like.

Further, in NR, a communication apparatus (which may be referred to as a relay apparatus) that relays signals between a user terminal (User Equipment (UE), which may be simply referred to as a terminal) and a radio base station (which may be simply referred to as a base station) has been studied.

### CITATION LIST

### Non-Patent Literature

NPL 1

3GPP TSG RAN WG1 #109-e, R1-2204534, Discussion on operation scenarios for NCR, May 9-20, 2022

### SUMMARY OF INVENTION

However, there is room for consideration regarding the appropriate control of the relay operation in a communication apparatus that performs relaying.

An aspect of the present disclosure provides a communication apparatus and a communication method capable of controlling an appropriate relay operation.

A communication apparatus according to an aspect of the present disclosure includes: a control section that controls, based on whether a simultaneous operation of a transmission operation or a reception operation in a first link between a base station and the communication apparatus and a transmission operation or a reception operation in a second link between the base station and the communication apparatus is supported, the transmission operation or the reception operation in the second link, the second link being used for transfer between the base station and a terminal; and a communication section that performs transmission or reception of a signal in the second link in accordance with the control by the control section.

A communication method according to an aspect of the present disclosure includes: controlling, by a communication apparatus, based on whether a simultaneous operation of a transmission operation or a reception operation in a first link between a base station and the communication apparatus and a transmission operation or a reception operation in a second link between the base station and the communication apparatus is supported, the transmission operation or the reception operation in the second link, the second link being used for transfer between the base station and a terminal; and performing, by the communication apparatus, transmission or reception of a signal in the second link in accordance with the controlling.

### BRIEF DESCRIPTION OF DRAWINGS

FIG. 1 is a diagram illustrating an exemplary radio communication system according to an embodiment of the present disclosure;

FIG. 2 is a diagram illustrating exemplary frequency ranges used in a radio communication system according to an embodiment of the present disclosure;

FIG. 3 is a diagram illustrating an exemplary configuration of a radio frame, a subframe, and a slot used in a radio communication system according to an embodiment of the present disclosure;

FIG. 4 is a diagram illustrating an exemplary configuration of NCR 300;

FIG. 5 is a diagram illustrating an example of Option 1 of Proposal 1;

FIG. 6 is a diagram illustrating examples of Option 2 of Proposal 1;

FIG. 7 is a diagram illustrating an example of Option 1 of Proposal 1A;

FIG. 8 is a diagram illustrating examples of Option 2 of Proposal 1A;

FIG. 9 is a diagram illustrating an exemplary resource of an SSB;

FIG. 10 is a block diagram illustrating an exemplary configuration of a base station according to an embodiment of the present disclosure;

FIG. 11 is a block diagram illustrating an exemplary configuration of a terminal according to an embodiment of the present disclosure;

FIG. 12 is a block diagram illustrating an exemplary configuration of a relay apparatus according to an embodiment of the present disclosure;

FIG. 13 illustrates an exemplary hardware configuration of a base station, a relay apparatus, and a terminal according to an embodiment of the present disclosure; and

FIG. 14 is a diagram illustrating an exemplary configuration of a vehicle.

### DESCRIPTION OF EMBODIMENTS

Hereinafter, an embodiment of the present disclosure will be described with reference to the drawings. Note that the embodiment described below are merely examples, and the embodiment to which the present disclosure is applied are not limited to the following embodiment.

Further, in the embodiment of the present disclosure described below, the terms such as Synchronization signal (SS), Primary SS (PSS), Secondary SS (SSS), Physical broadcast channel (PBCH), Physical random access channel (PRACH), Physical Downlink Control Channel (PDCCH), Physical Downlink Shared Channel (PDSCH), Physical Uplink Control Channel (PUCCH), Physical Uplink Shared Channel (PUSCH), and the like, which are used in 5G New Radio (NR), are used. This is for the sake of convenience in description, and the same signals, functions, and the like may be called by other names.

Further, in the embodiment of the present disclosure, the duplex method may be a Time Division Duplex (TDD) method, a Frequency Division Duplex (FDD) method, or another method (for example, a Flexible Duplex method).

Further, in the embodiment of the present disclosure, the phrase “a radio parameter or the like is “configured,”” may refer to pre-configuration of a predetermined value or configuration of a radio parameter that is indicated from a base station or a terminal.

### <Radio Communication System>

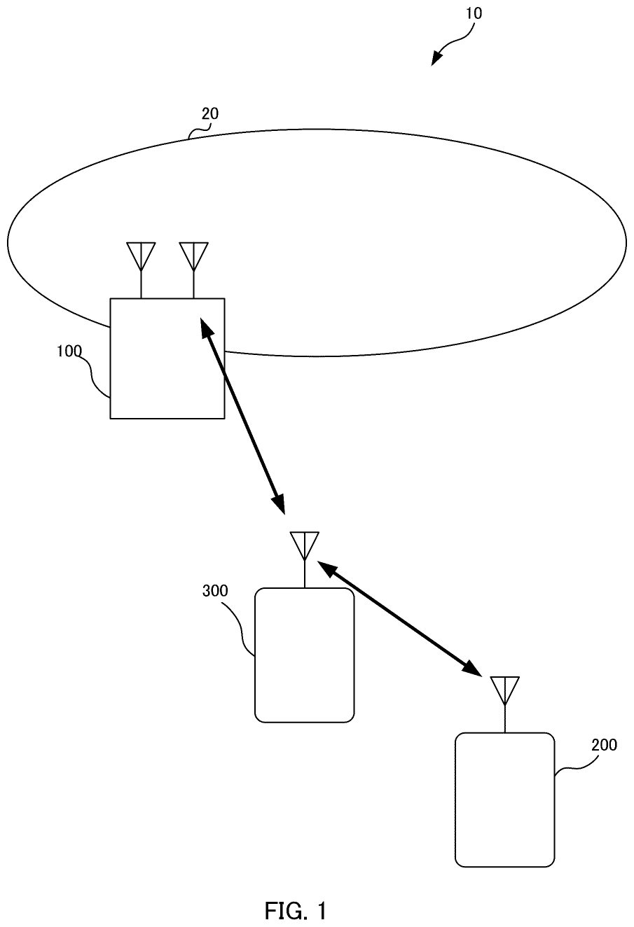

FIG. 1 is a diagram illustrating exemplary radio communication system 10 according to an embodiment of the present disclosure. Radio communication system 10 is a radio communication system in accordance with 5G NR, and includes Next Generation-Radio Access Network 20 (hereinafter, referred to as NG-RAN 20) and terminal 200 (hereinafter, also referred to as user equipment (UE) 200).

Note that radio communication system 10 may be a radio communication system in accordance with a method called Beyond 5G, 5G Evolution, or 6G.

NG-RAN 20 includes base station 100 (hereinafter also referred to as gNB 100). Note that the number of gNBs and UEs is not limited to the example shown in FIG. 1.

NG-RAN 20 actually includes a plurality of NG-RAN nodes, specifically, gNBs (or ng-eNBs), and is connected to a core network (5GC, not illustrated) in accordance with 5G. Note that NG-RAN 20 and 5GC may be simply referred to as “network.” Further, in the following, gNB may be read as a network (NW).

For example, gNB 100 is a base station in accordance with 5G, and performs radio communication with UE 200 in accordance with 5G. Further, in the example illustrated in FIG. 1, relay apparatus 300 that relays signals between gNB 100 and UE 200 is illustrated. Relay apparatus 300 performs a relay operation of, for example, transmitting a signal received from gNB 100 to UE 200 and transmitting a signal received from UE 200 to gNB 100. Note that the term “relaying” may be replaced with the term “forwarding.” Further, the term “operation” may be replaced with the term “processing,” “control,” or the like. Further, relay apparatus 300 which is being studied in NR will be described later.

gNB 100 and UE 200 may support MIMO (Multiple-Input Multiple-Output) that generates a beam with higher directivity by controlling a radio signal transmitted from a plurality of antenna elements, carrier aggregation (CA) that uses a plurality of component carriers (CCs) in a bundled manner, and dual connectivity (DC) that performs communication between UE and each of two NG-RAN nodes.

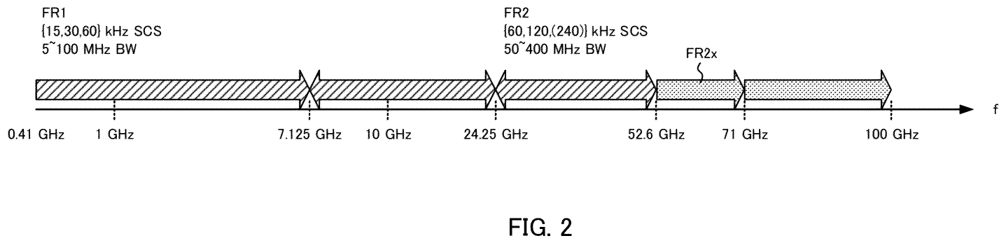

Further, radio communication system 10 may support a plurality of frequency ranges (FRs). FIG. 2 is a diagram illustrating examples of FRs used in radio communication system 10. As illustrated in FIG. 2, radio communication system 10 may support FR1 and FR2. The frequency band of each FR is, for example, as follows.
FR1: 410 MHz to 7.125 GHz
FR2: 24.25 GHz to 52.6 GHz

In FR1, a sub-carrier spacing (SCS) of 15 kHz, 30 kHz, or 60 kHz may be used, and a bandwidth (BW) of 5 to 100 MHz may be used. FR2 is a higher frequency than FR1, and an SCS of 60 kHz or 120 kHz (240 kHz may be included) is used, and a bandwidth (BW) of 50 to 400 MHz may be used.

Note that SCS may be interpreted as numerology. Numerology is defined in 3GPP TS 38.300 and corresponds to one subcarrier spacing in the frequency domain.

Further, radio communication system 10 may support a frequency band higher than the frequency band of FR2. Specifically, radio communication system 10 may support a frequency band exceeding 52.6 GHz and up to 114.25 GHz. Such a high frequency band may be referred to as “FR2x” for convenience. In a case where a band exceeding 52.6 GHz is used, Cyclic Prefix-Orthogonal Frequency Division Multiplexing (CP-OFDM)/Discrete Fourier Transform-Spread-Orthogonal Frequency Division Multiplexing (DFT-S-OFDM) with a larger SCS may be applied.

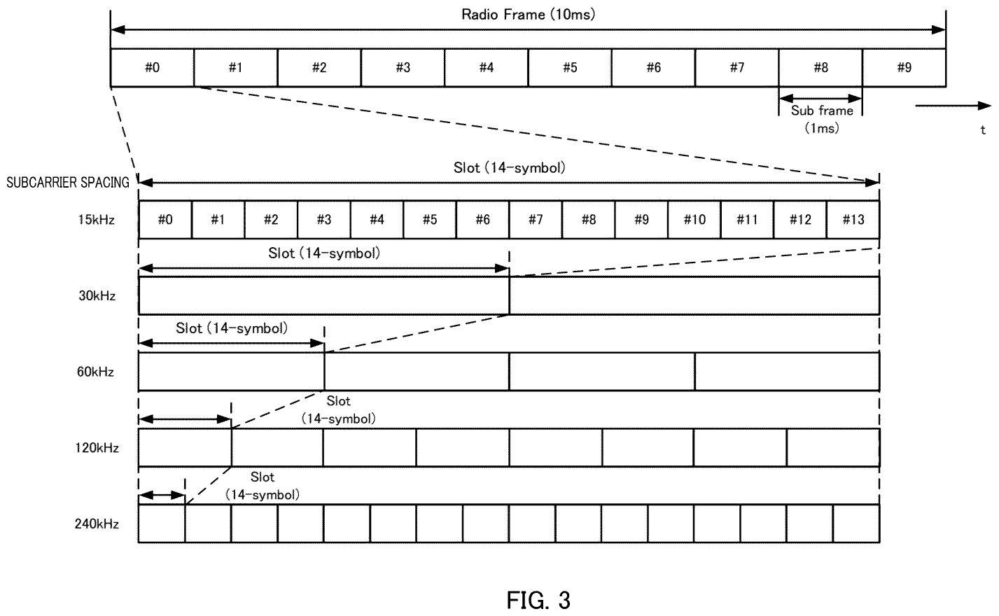

FIG. 3 is a diagram illustrating an exemplary configuration of a radio frame (system frame), a subframe, and a slot used in radio communication system 10. As illustrated in FIG. 3, one slot is configured with 14 symbols, and the symbol duration (and the slot duration) becomes shorter as the SCS becomes larger (wider). Note that the SCS is not limited to the durations (frequencies) illustrated in FIG. 3. For example, 480 kHz, 960 kHz, or the like may be used as the SCS.

Further, the number of symbols constituting one slot is not necessarily 14 symbols (for example, the number of symbols may be 28 or 56 symbols). Further, the number of slots per subframe may vary depending on the SCS.

Note that the time direction (t) illustrated in FIG. 3 may be referred to as a time domain, a symbol period, a symbol time, or the like. Further, the frequency direction may be referred to as a frequency domain, a resource block, a subcarrier, a bandwidth part (BWP), or the like.

gNB 100 transmits control information, configuration information, and the like of gNB 100 to UE 200 as a downlink (DL) signal.

Further, for example, gNB 100 receives, as an uplink (UL) signal, control information of gNB 100, a data signal, information on the processing capability of UE 200 (terminal capability (information); for example, UE capability), and the like from UE 200.

Relay apparatus 300 performs a transfer operation of transferring the DL signal to UE 200. Further, relay apparatus 300 performs a transfer operation of transferring the UL signal to gNB 100. Note that, in the following, the UL signal received by gNB 100 from UE 200 and/or the DL signal received by UE 200 from gNB 100 may be a signal relayed by relay apparatus 300.

UE 200 is a communication apparatus with a radio communication function, such as a smartphone, a mobile phone, a tablet, a wearable terminal, or a communication module for Machine-to-Machine (M2M).

UE 200 receives a control signal or a data signal from gNB 100 in DL and transmits a control signal or a data signal to gNB 100 in UL, thereby utilizing various communication services provided by radio communication system 10. Further, UE 200 receives various reference signals transmitted from gNB 100 and performs measurement of the propagation path quality based on the reception result of the reference signals.

The channel used for DL signal transmission includes, for example, a data channel and a control channel. For example, the data channel may include a Physical Downlink Shared Channel (PDSCH), and the control channel may include a Physical Downlink Control Channel (PDCCH). For example, gNB 100 transmits control information to UE 200 using PDCCH and transmits a DL data signal using PDSCH. Note that PDSCH is an example of a downlink shared channel, and PDCCH is an example of a downlink control channel. Note that the PDCCH may be read as downlink control information (DCI), control information, or the like transmitted in the PDCCH.

The reference signal included in the DL signal may include, for example, at least one of a demodulation reference signal (DMRS), a phase tracking reference signal (PTRS), a channel state information-reference signal (CSI-RS), a sounding reference signal (SRS), and a positioning reference signal (PRS). For example, reference signals such as DMRS and PTRS are used for demodulation of a data signal in DL and are transmitted using PDSCH.

The channel used for UL signal transmission includes, for example, a data channel and a control channel. For example, the data channel may include a Physical Uplink Shared Channel (PUSCH), and the control channel may include a Physical Uplink Control Channel (PUCCH). For example, UE 200 transmits control information using PUCCH and transmits a UL data signal using PUSCH. Note that PUSCH is an example of an uplink shared channel, and PUCCH is an example of an uplink control channel. The shared channel may also be referred to as a data channel. Note that PUSCH or PUCCH may be read as uplink control information (UCI), control information, or the like transmitted in PUSCH or PUCCH.

The reference signal included in the UL signal may include, for example, at least one of DMRS, PTRS, CSI-RS, SRSRS, and PRS for position information. For example, reference signals such as DMRS and PTRS are used for demodulation of UL data signals and are transmitted using PUSCH.

### <Relay Apparatus>

In Release 18 (Rel-18) of 3GPP, a new study item on NR Network-controlled Repeater is being considered. Hereinafter, a NR Network-controlled Repeater is abbreviated as NCR. NCR may correspond to, for example, relay apparatus 300 of FIG. 1. Hereinafter, NCR is sometimes referred to as NCR 300.

In NCR, unlike a conventional amplify and forward repeater, at least one of the control of the timing of transmission, the control of the timing of reception, the control of whether to perform a DL operation or a UL operation (for example, switching), and the control of turning ON and OFF the operation of NCR may be executed. Further, in NCR, it is possible to control the directivity in the transmission operation and/or the reception operation. That is, in NCR, the beam to be transmitted and/or the beam to be received may be controlled.

Hereinafter, control of turning ON and OFF the operation of NCR will be described by way of example.

For example, the following scenarios and/or assumptions have been considered with respect to NCR.

NCR may be an inband radio frequency (RF) repeater used to extend the network coverage of the FR1 and FR2 bands. Note that, in the study on FR2, the use of FR2 in both outdoor and outdoor to indoor (O2I) scenarios may be prioritized.

At present, a single-hop fixed NCR is being considered.

NCR may be transparent to the UE.

NCR may maintain and control the link between the gNB and the repeater and the link between the repeater and the UE simultaneously.

The efficiency of the cost of NCR is a consideration for NCR.

Further, the following examples are given as side control information.
Information on beamforming
Information on the timing for aligning the boundary between transmission and reception of NCR
Information on TDD configuration for UL and/or DL
Information on control of ON and OFF of NCR for efficient interference management and energy efficiency improvement (hereinafter referred to as ON-OFF control information)
Information on power control for efficient interference management

Note that, among the examples of the side control information described above, the information necessary for NCR is under consideration. Further, in this study, it may be assumed that the NCR operates at the maximum transmission power.

Further, a method of L1/L2 (layer 1/layer 2) signaling for transmitting the side control information and a configuration of the L1/L2 signaling are under consideration.

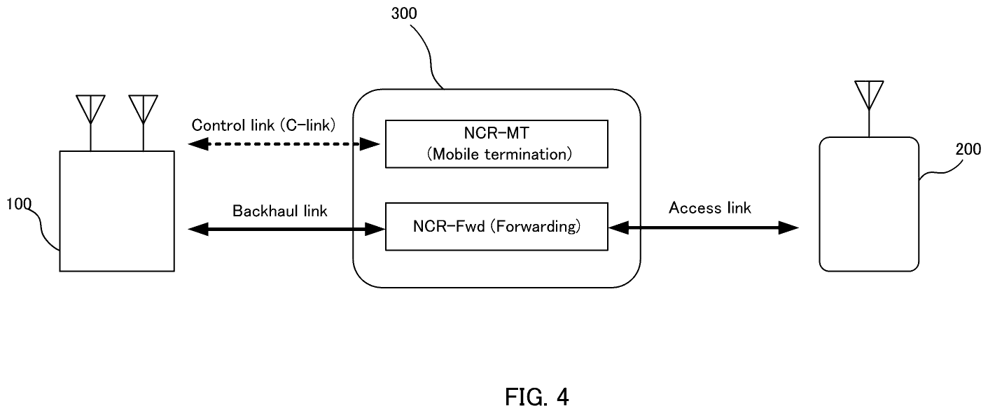

FIG. 4 is a diagram illustrating an exemplary configuration of NCR 300. NCR 300 is present between UE 200 and gNB 100. Note that, NCR 300 may be present between UE 200 and gNB 100 in the real space, or need not be present between UE 200 and gNB 100 in the real space.

NCR 300 receives a UL signal transmitted from UE 200 to gNB 100 and transmits the UL signal to the destination gNB 100. In other words, NCR 300 transfers the UL signal transmitted from UE 200 to gNB 100 to the destination gNB 100. Further, NCR 300 receives a DL signal transmitted from gNB 100 to UE 200 and transmits the DL signal to the destination UE 200. In other words, NCR 300 transfers a signal transmitted from gNB 100 to UE 200 to the destination UE 200.

Further, NCR 300 may operate based on control information received from gNB 100.

As illustrated in FIG. 4, the link between NCR 300 and UE 200 may be referred to

as an access link. Further, as illustrated in FIG. 4, two links exist between NCR 300 and gNB 100. Of the two links, the link that transmits a signal received from UE 200 to gNB 100 may be referred to as a backhaul link. Note that, in the backhaul link, NCR 300 may receive a signal for UE 200 from gNB 100. Of the two links, the link for exchanging information between gNB 100 and NCR 300 may be referred to as a control link (hereinafter, sometimes referred to as a C-link). For example, in the control link, exchange of side control information may be performed.

Note that, in FIG. 4, an example is illustrated in which gNB 100 included in the C-link and gNB 100 included in the backhaul link are the same, but gNB 100 included in the C-link and gNB 100 included in the backhaul link may be different from each other.

Further, the frequency (for example, carrier or frequency band) used for communication in the C-link, the frequency used for communication in the backhaul link, and the frequency band used for communication in the access link are not particularly limited. These three frequencies may be the same as each other, or at least two of the three frequencies may be different from each other. Further, one of the three frequencies may include another one of the frequencies.

Further, for each of the three links, C-link, backhaul link, and access link, the link in the direction toward gNB 100 may be referred to as an uplink, and the link in the direction opposite to the uplink may be referred to as a downlink. In this case, the frequency used for uplink communication and the frequency used for downlink communication in each of the three links may be the same as each other or may be different from each other.

NCR 300 in FIG. 4 includes two functional entities referred to as NCR-MT and NCR-Fwd.

NCR-MT is a functional entity that communicates with gNB 100 via a control link (C-link) and enables information exchange with gNB 100. The information exchange with gNB 100 may be, for example, transmission and reception of side control information. Further, the control link may be based on the Uu interface of NR.

Note that, in NCR-MT, the side control information may include at least information for controlling NCR-Fwd. Further, the side control information may be indicated by at least one signaling of radio resource control (RRC), Medium Access Control Control Element (MAC CE), and downlink control information (DCI).

NCR-Fwd is a functional entity that transfers signals between gNB and UE via a backhaul link and an access link. For example, NCR-Fwd performs amplification and transfer of a UL radio frequency (RF) signal. Further, the amplification and transfer of the RF signal in the DL are performed. Note that the operation of NCR-Fwd may be controlled in accordance with the side control information received from gNB 100.

For the NCR illustrated in FIG. 4, it was agreed in 3GPP RAN1 #109 that ON-OFF control of NCR would be supported.

For example, it has been agreed that the ON-OFF control information is valid for controlling the operation (or behavior) of NCR-Fwd in the ON-OFF control. However, the mechanism for indicating and determining ON-OFF control is under consideration. Further, an explicit indication or an implicit indication of the ON-OFF control information is under consideration.

Further, in RAN1 #109, the following points were agreed upon regarding transmission and reception in the C-link of NCR and transmission and reception in the backhaul link of NCR.

It was agreed that the UL of the C-link and the UL of the backhaul link are executed by time division multiplexing (TDM). On the other hand, simultaneous transmission of the UL of the C-link and the UL of the backhaul link depends on the function or capability of NCR. That is, NCR may have the capability to perform simultaneous transmission of the UL of the C-link and the UL of the backhaul link.

Further, the DL of the C-link and the DL of the backhaul link may be performed simultaneously or may be performed by TDM.

Note that, multiplexing using a TDM scheme or the like is controlled by gNB in consideration of the capability of NCR. For example, the TDM between the UL of the C-link and the UL of the backhaul link is controlled by gNB in consideration of the capability of NCR.

Note that, since the UL transmission in the C-link executed by NCR is executed by NCR-MT, which is a functional entity, the UL transmission is sometimes referred to as “NCR-MT C-link UL Tx.” Further, since the UL transmission in the backhaul link executed by NCR is executed by NCR-Fwd, which is a functional entity, the UL transmission is sometimes referred to as “NCR-Fwd backhaul link UL Tx.” Note that the UL transmission in the backhaul link executed by NCR may be coordinated with the UL reception in the access link. In a case where the UL transmission is coordinated with the UL reception in the access link, “NCR-Fwd backhaul link UL Tx” may include UL transmission in the backhaul link and UL reception in the access link.

Further, similarly for DL, the DL reception in the C-link executed by NCR is sometimes referred to as “NCR-MT C-link DL Rx,” and the DL reception in the backhaul link executed by NCR is sometimes referred to as “NCR-Fwd backhaul link DL Rx.” Note that the DL reception in the backhaul link executed by NCR may be coordinated with the DL transmission in the access link. In a case where the DL reception is coordinated with the DL transmission in the access link, “NCR-Fwd backhaul link DL Rx” may include DL reception in the backhaul link and DL transmission in the access link in NCR.

### <Consideration>

In relation to the agreement on NCR, there is room for various considerations in the ON-OFF control of NCR.

For example, it has been considered that the simultaneous transmission of NCR-MT C-link UL Tx and NCR-Fwd backhaul link UL Tx depends on the function or capability of NCR, but there is room for consideration in a method for controlling ON-OFF of NCR depending on whether this simultaneous transmission is supported or not. Also regarding simultaneous operation in NCR other than simultaneous transmission of NCR-MT C-link UL Tx and NCR-Fwd backhaul link UL Tx, there is room for consideration in a method for controlling ON-OFF of NCR depending on whether the simultaneous operation is supported or not. Note that, the simultaneous operation in NCR other than the simultaneous transmission of NCR-MT C-link UL Tx and NCR-Fwd backhaul link UL Tx may be, for example, the simultaneous reception of NCR-MT C-link DL Rx and NCR-Fwd backhaul link DL Rx.

For example, in a case where a simultaneous operation is not supported, it is desirable to perform ON-OFF control such that the simultaneous operation is not performed. In a case where ON-OFF control that causes a simultaneous operation is performed despite the fact that the simultaneous operation is not supported, a collision (or interference) of signals occurs on the reception side (for example, gNB or NCR), resulting in a deterioration in communication quality. Further, in this case, the power consumption increases by turning NCR ON to perform the simultaneous operation.

Further, in a case where a simultaneous operation is supported, it is desirable to perform efficient ON-OFF control considering that the simultaneous operation is possible. For example, in a case where a simultaneous operation is possible, when NCR receives an indication related to one operation, NCR can turn the other operation ON based on the indication, and thus, it is possible to omit communication required for the indication and to perform efficient control.

Although the target signal to be transferred by NCR has not been agreed in the current agreement, there is room for consideration in a method of controlling ON-OFF of NCR depending on the target signal to be transferred by NCR.

For example, in a case where NCR is turned ON and a signal is transferred even though the signal is not desired to be transferred by NCR, the power consumption increases by unnecessarily turning NCR ON. Further, the transferred signal interferes with another signal. On the other hand, in a case where NCR is turned OFF even though a signal is desired to be transferred by NCR, the transfer is not executed, resulting in a deterioration in communication quality.

As described above, there is room for consideration regarding the ON-OFF control of NCR, that is, the control of the operation related to transfer at NCR. Hereinafter, an example of appropriate ON-OFF control of NCR for the above-described problem will be described.

### <Proposal 1>

In Proposal 1, a case where the simultaneous operation of NCR-MT C-link UL Tx and NCR-Fwd backhaul link UL Tx is not supported is described as an example of the simultaneous operation in NCR.

It is assumed that a time-frequency resource (hereinafter, sometimes abbreviated as a resource) is allocated to each of communication in a C-link and communication in a backhaul link. The indication of this allocation is performed by an NW (for example, gNB).

The indication of this resource allocation has not been sufficiently studied. For example, the resource indicated for communication in the C-link and the resource indicated for communication in the backhaul link possibly do not overlap with each other in both the time direction and the frequency direction. On the other hand, for example, the resource indicated for communication in the C-link and the resource indicated for communication in the backhaul link possibly overlap with each other in at least one of the time direction and the frequency direction.

Such an overlap between the resource allocated for communication in the C-link and the resource allocated for communication in the backhaul link, and whether the simultaneous operation of NCR is supported need to be consistent with each other. For example, in a case where resources overlap with each other despite the fact that the simultaneous operation of NCR is not supported, inappropriate control is possibly performed on the overlapping resources.

For example, in a case where the simultaneous operation of NCR is not supported, it is desirable that the resource allocated for communication in the C-link and the resource allocated for communication in the backhaul link do not overlap.

Note that, the case where the simultaneous operation of NCR is not supported may be interpreted as a case where NCR does not have the capability to perform the simultaneous operation, a case where the simultaneous operation is not enabled, or a case where the simultaneous operation is not configured. Further, the case where the simultaneous operation of NCR is not supported may be interpreted as a case where the simultaneous operation is not supported in a gNB and/or a UE, which are communication partners of NCR.

For example, in a case where the simultaneous operation of NCR-MT C-link UL Tx and NCR-Fwd backhaul link UL Tx is not supported in NCR, there is room for consideration as to whether the resource indicated for NCR-MT C-link UL Tx and the resource indicated for NCR-Fwd backhaul link UL Tx possibly temporally overlap. Further, in this case, there is room for consideration as to which resource to be prioritized between the resource indicated for NCR-MT C-link UL Tx and the resource indicated for NCR-Fwd backhaul link UL Tx.

Thus, Proposal 1 describes an operation relating to a temporal overlap between a resource indicated for NCR-MT C-link UL Tx and a resource indicated for NCR-Fwd backhaul link UL Tx in a case where the simultaneous operation of NCR-MT C-link UL Tx and NCR-Fwd backhaul link UL Tx is not supported in NCR.

In the following, executing an operation (for example, transmission operation) of NCR-MT C-link UL Tx is sometimes described as executing NCR-MT C-link UL Tx, and executing an operation (for example, transmission operation) of NCR-Fwd backhaul link UL Tx is sometimes described as executing NCR-Fwd backhaul link UL Tx.

A case where the simultaneous operation of NCR-MT C-link UL Tx and NCR-Fwd backhaul link UL Tx is not supported in NCR may be interpreted as a case where the simultaneous operation of UL reception in the C-link and UL reception in the backhaul link is not supported in gNB.

### <Option 1 of Proposal 1>

In Option 1 of Proposal 1, in a case where the simultaneous operation of NCR-MT C-link UL Tx and NCR-Fwd backhaul link UL Tx is not supported in NCR, NCR does not assume that the resource indicated for NCR-MT C-link UL Tx and the resource indicated for NCR-Fwd backhaul link UL Tx temporally overlap with each other. For example, in a case where the simultaneous operation of NCR-MT C-link UL Tx and NCR-Fwd backhaul link UL Tx is not supported in NCR, when performing one of the operations of NCR-MT C-link UL Tx and NCR-Fwd backhaul link UL Tx, NCR does not perform the other operation.

In other words, in a case where the simultaneous operation of NCR-MT C-link UL Tx and NCR-Fwd backhaul link UL Tx is not supported in NCR, the resource indicated for NCR-MT C-link UL Tx and the resource indicated for NCR-Fwd backhaul link UL Tx need not temporally overlap with each other. That is, in this case, the side that indicates the resources (for example, NW (for example, gNB)) may configure the resource for NCR-MT C-link UL Tx and the resource for NCR-Fwd backhaul link UL Tx to resources that do not temporally overlap with each other.

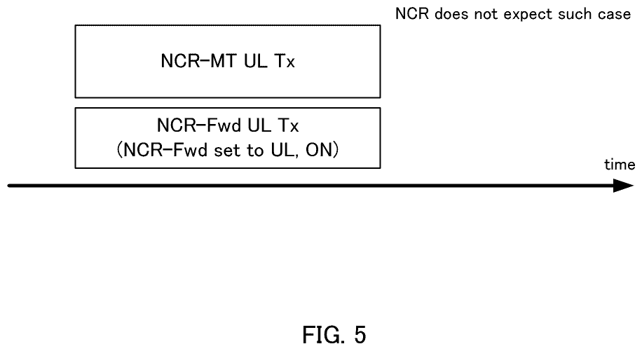

FIG. 5 is a diagram illustrating an example of Option 1 of Proposal 1. FIG. 5 illustrates an example of Option 1 of Proposal 1. Note that the horizontal axis in the example of FIG. 5 represents the time axis. Further, “NCR-MT UL Tx” in FIG. 5 represents a resource indicated for NCR-MT C-link UL Tx, and “NCR-Fwd UL Tx” represents a resource indicated for NCR-Fwd backhaul link UL Tx. In FIG. 5, “NCR-MT UL Tx” and “NCR-Fwd UL Tx” overlap with each other in the time direction.

As illustrated in FIG. 5, in Option 1 of Proposal 1, a case as in FIG. 5 need not be assumed.

Note that FIG. 5 illustrates a case where two resources completely overlap with each other in the time direction, but the present disclosure is not limited thereto. For example, NCR need not assume a case where two resources partially overlap with each other in the time direction.

By the indication of resources as described in Option 1 of Proposal 1, in a case where the simultaneous operation of NCR-MT C-link UL Tx and NCR-Fwd backhaul link UL Tx is not supported in NCR, the indication of resources that can ensure the consistency between the indication of resources and the presence or absence of support is performed, thereby realizing appropriate ON-OFF control of NCR.

### <Option 2 of Proposal 1>

In Option 2 of Proposal 1, a case is described in which a resource indicated for NCR-MT C-link UL Tx and a resource indicated for NCR-Fwd backhaul link UL Tx possibly temporally overlap with each other in a case where the simultaneous operation of NCR-MT C-link UL Tx and NCR-Fwd backhaul link UL Tx is not supported in NCR.

That is, in Option 2 of Proposal 1, NCR may assume that the resource indicated for NCR-MT C-link UL Tx and the resource indicated for NCR-Fwd backhaul link UL Tx temporally overlap. Note that, since NCR does not support the simultaneous operation of NCR-MT C-link UL Tx and NCR-Fwd backhaul link UL Tx, in a case where the resource indicated for NCR-MT C-link UL Tx and the resource indicated for NCR-Fwd backhaul link UL Tx temporally overlap with each other, NCR may perform one of the operations of NCR-MT C-link UL Tx and NCR-Fwd backhaul link UL Tx and need not perform the other operation.

Further, in the case of Option 2 of Proposal 1, the resource indicated for NCR-MT C-link UL Tx and the resource indicated for NCR-Fwd backhaul link UL Tx may temporally overlap. That is, in this case, the side that indicates the resources (for example, NW (for example, gNB)) may configure the resource for NCR-MT C-link UL Tx and the resource for NCR-Fwd backhaul link UL Tx to resources that temporally overlap with each other.

Hereinafter, Options 2-1 to 2-3 will be described as three options for Option 2 in Proposal 1.

### <Option 2-1 of Proposal 1>

In Option 2-1 of Proposal 1, which operation, NCR-MT C-link UL Tx or NCR-Fwd backhaul link UL, NCR performs depends on the implementation of NCR. In this case, which operation, NCR-MT C-link UL Tx or NCR-Fwd backhaul link UL, NCR performs may be different for each NCR. For example, in a case where the resource indicated for NCR-MT C-link UL Tx and the resource indicated for NCR-Fwd backhaul link UL Tx temporally overlap with each other, a certain NCR may perform NCR-MT C-link UL Tx in the resource indicated for NCR-MT C-link UL Tx, and another NCR may perform NCR-MT C-link UL Tx in the resource indicated for NCR-Fwd backhaul link UL Tx.

For example, which operation, NCR-MT C-link UL Tx or NCR-Fwd backhaul link UL Tx, to be performed may be configured in advance or may be switched dynamically (or statically).

NCR may switch operations between NCR-MT C-link UL Tx and NCR-Fwd backhaul link UL Tx based on an indication received from NW, for example.

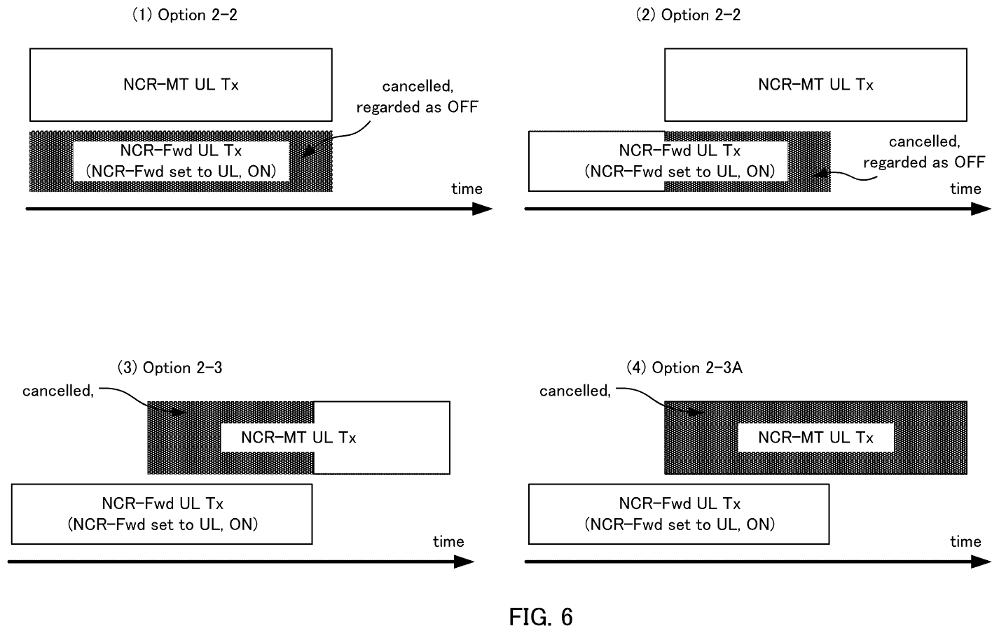

Next, Options 2-2 and 2-3 of Proposal 1 will be described with reference to the drawing. FIG. 6 is a diagram illustrating examples of Option 2 of Proposal 1. FIG. 6 illustrates examples of Options 2-2, 2-3, and 2-3A of Proposal 1. Note that the horizontal axis in each example in FIG. 6 represents the time axis. Further, “NCR-MT UL Tx” in FIG. 6 represents a resource indicated for NCR-MT C-link UL Tx, and “NCR-Fwd UL Tx” represents a resource indicated for NCR-Fwd backhaul link UL Tx.

### <Option 2-2 of Proposal 1>

In Option 2-2 of Proposal 1, in a case the resource indicated for NCR-MT C-link UL Tx and the resource indicated for NCR-Fwd backhaul link UL Tx temporally overlap with each other, NCR performs NCR-MT C-link UL Tx for the resource part that temporally overlaps. In this case, NCR does not need to perform NCR-Fwd backhaul link UL Tx for the resource part that temporally overlaps. That is, here, NCR-Fwd may be regarded as “off” for the time overlapped resource.

Note that, in the following, a resource part that temporally overlaps in a case where the resource indicated for NCR-MT C-link UL Tx and the resource indicated for NCR-Fwd backhaul link UL Tx temporally overlap with each other is sometimes described as a “time overlapped resource.” For example, in Option 2-2 of Proposal 1, the NCR performs the operation of NCR-MT C-link UL Tx for the time overlapped resource.

As illustrated in part (1) of FIG. 6, in Option 2-2, the operation of NCR-Fwd backhaul link UL Tx is not performed (regarded as off) for the time overlapped resource.

Further, as illustrated in part (2) of FIG. 6, in Option 2-2, in a case where the time overlapped resource is partially present, the operation of NCR-Fwd backhaul link UL Tx is not partially performed (regarded as off). Further, in this case, the operation of NCR-Fwd backhaul link UL Tx may be performed in a resource that does not temporally overlap.

### <Option 2-3 of Proposal 1>

In Option 2-3 of Proposal 1, NCR performs the operation of NCR-Fwd backhaul link UL Tx for the time overlapped resource. In this case, NCR does not need to perform the operation of NCR-MT C-link UL Tx for the time overlapped resource. In other words, in this case, the operation of NCR-MT C-link UL Tx may be canceled.

As illustrated in part (3) of FIG. 6, in Option 2-3, the operation of NCR-MT C-link UL Tx need not be performed for the time overlapped resource. Further, in this case, the operation of NCR-MT C-link UL Tx may be performed in a resource that does not temporally overlap.

### <Option 2-3A of Proposal 1>

In Option 2-3A of Proposal 1, NCR performs the operation of NCR-Fwd backhaul link UL Tx for the time overlapped resource. This operation is the same as in Option 2-3. In Option 2-3, NCR need not perform the operation of NCR-MT C-link UL Tx for the resource that is indicated for NCR-MT C-link UL Tx and includes the time overlapped resource. In other words, in this case, the operation of NCR-MT C-link UL Tx may be canceled over the entire resource.

As illustrated in part (4) of FIG. 6, in Option 2-3A, the operation of NCR-MT C-link UL Tx need not be performed for the time overlapped resource. Further, in this case, the operation of NCR-MT C-link UL Tx need not be performed even for the resource that does not temporally overlap.

Note that the method (for example, allocation method) for indicating the resource of NCR-MT C-link UL Tx and the resource of NCR-Fwd backhaul link UL Tx is not particularly limited.

For example, NCR-MT C-link UL Tx may be, illustratively, any of PUSCH transmission, PUCCH transmission, PRACH transmission, and SRS transmission. Further, the resource for NCR-MT C-link UL Tx may be indicated to NCR in the same manner as the indication in the case of allocating the resource to the UE.

Note that the resource for NCR-MT C-link UL Tx may be indicated to NCR in a manner different from the indication in the case of allocating the resource to the UE.

Further, the resource for NCR-Fwd backhaul link UL Tx may be indicated explicitly or implicitly. For example, the resource for NCR-Fwd backhaul link UL Tx may be explicitly or implicitly indicated to NCR-Fwd that the resource is for “UL.” Alternatively, the resource for NCR-Fwd backhaul link UL Tx may be explicitly or implicitly indicated to be “ON” for NCR-Fwd. For example, the indication of the resource for NCR-Fwd backhaul link UL Tx may correspond to an indication of ON or OFF of NCR-Fwd. Hereinafter, the ON or OFF of NCR-Fwd is sometimes described as “NCR-Fwd ON-OFF.”

Further, each option (each of Options 1, 2-1, 2-2, 2-3, and 2-3A) of Proposal 1 described above may be combined with the method for indicating the resource described above. For example, among the options, the option to be applied may be changed depending on the method for indicating the resource described above and the resource to be indicated.

For example, a case is described in which the resource indicated for NCR-MT C-link UL Tx is a resource for PUSCH transmission, PUCCH transmission, SRS transmission, or PRACH transmission.

For example, in a case where NCR-MT C-link UL Tx is PUSCH transmission, any of the options of Proposal 1 described above may be applied when the PUSCH transmitted by the operation of NCR-MT C-link UL Tx is a dynamic grant PUSCH indicated by DCI, a type 1 configured grant PUSCH, or a type 2 configured grant PUSCH. Further, the options applied to these PUSCHs may be different from one another or may be the same.

For example, in a case where NCR-MT C-link UL Tx is a PUCCH transmission, any of the options of Proposal 1 described above may be applied when the PUCCH transmitted by the operation of NCR-MT C-link UL Tx is a dynamic PUCCH indicated by DCI or a semi-static PUCCH configured by RRC. Further, the options applied to these PUCCHs may be different from each other or may be the same.

Further, for example, in a case where NCR-MT C-link UL Tx is a PUCCH transmission, any of the options of Proposal 1 described above may be applied when the PUCCH transmitted by the operation of NCR-MT C-link UL Tx is a PUCCH for scheduling request (SR), a PUCCH for channel state information (CSI), or a PUCCH for hybrid automatic repeat request (HARQ). Further, the options applied to these PUCCHs may be different from one other or may be the same.

Further, for example, in a case where NCR-MT C-link UL Tx is a PUCCH transmission for CSI, any of the options of Proposal 1 described above may be applied when the PUCCH for CSI transmitted by the operation of NCR-MT C-link UL Tx is a PUCCH for periodic CSI, a PUCCH for semi-persistent CSI, or a PUCCH for aperiodic CSI. Further, the options applied to these PUCCHs for CSI may be different from one another or may be the same.

For example, in a case where NCR-MT C-link UL Tx is an SRS transmission, any of the options in Proposal 1 described above may be applied when the SRS transmitted by the operation of NCR-MT C-link UL Tx is a periodic SRS, a semi-persistent SRS, or an aperiodic SRS. Further, the options applied to these SRSs may be different from one another or may be the same.

Further, for example, in a case where NCR-MT C-link UL Tx is an SRS transmission, any of the options in Proposal 1 described above may be applied depending on the use of the SRS transmitted by the operation of NCR-MT C-link UL Tx. For example, in a case where NCR-MT C-link UL Tx is SRS transmission, any of the options in Proposal 1 described above may be applied when the usage of the SRS transmitted by the operation of NCR-MT C-link UL Tx is set to “codebook,” “non-codebook,” “beam management,” or “antenna switching.” Further, the options applied to these SRSs may be different from one another or may be the same.

For example, in a case where NCR-MT C-link UL Tx is a PRACH transmission, any of the options of Proposal 1 described above may be applied when the PRACH transmitted by the operation of NCR-MT C-link UL Tx is a RACH triggered by a PDCCH order or a RACH triggered by a MAC layer or an RRC layer. Further, the options applied to these PRACHs may be different from each other or may be the same.

Next, each option of Proposal 1 in accordance with the indication of the resource for NCR-Fwd backhaul link UL Tx will be described.

For example, any of the options of Proposal 1 described above may be applied in a case where NCR-Fwd backhaul link UL Tx (for example, NCR-Fwd ON-OFF) is explicitly or implicitly indicated. Further, the option to be applied may be different or the same between the case of an explicit indication and the case of an implicit indication.

For example, any of the options of Proposal 1 described above may be applied in a case where NCR-Fwd backhaul link UL Tx (for example, NCR-Fwd ON-OFF) is indicated dynamically or semi-statically. Further, the option to be applied may be different or the same between the case of a dynamic indication and the case of a semi-static indication.

For example, any of the options of Proposal 1 described above may be applied in a case where NCR-Fwd backhaul link UL Tx (for example, NCR-Fwd ON-OFF) is indicated by DCI or MAC CE or RRC. Further, the option to be applied may be different or the same among the cases of an indication by DCI, an indication by MAC CE, and an indication by RRC.

At least one of the cases described above for NCR-MT C-link UL Tx and at least one of the cases described above for NCR-Fwd backhaul link UL Tx may be combined. Then, any of the options of Proposal 1 described above may be applied to this combination. Note that, depending on the difference in the combination, the options to be applied may differ from one another or may be the same.

For example, when the PUSCH transmitted in the operation of NCR-MT C-link UL Tx is a dynamic grant PUSCH, and NCR-Fwd backhaul link UL Tx (for example, NCR-Fwd ON-OFF) is indicated semi-statically, any of the options of Proposal 1 described above may be applied.

As shown in Option 2 of Proposal 1, preferentially using one of the two resources and not using the other makes it possible to achieve consistency between the presence or absence of support and the overlap of resources by performing appropriate control in the time overlapped resource in a case where the simultaneous operation of NCR-MT C-link UL Tx and NCR-Fwd backhaul link UL Tx is not supported in NCR, thereby realizing appropriate ON-OFF control of NCR.

### <Proposal 1A>

In Proposal 1A, a case where the simultaneous operation of NCR is not supported is be described in the same manner as in Proposal 1. Proposal 1A describes a case where the simultaneous operation of NCR-MT C-link DL Rx and NCR-Fwd backhaul link DL Rx, as an example of the simultaneous operation in NCR, is not supported in NCR.

As in Proposal 1, the overlap between the resource allocated for communication in the C-link and the resource allocated for communication in the backhaul link, and whether the simultaneous operation of NCR is supported need to be consistent with each other.

For example, in a case where the simultaneous operation of NCR-MT C-link DL Rx and NCR-Fwd backhaul link DL Rx is not supported in NCR, there is room for consideration as to whether the resource indicated for NCR-MT C-link DL Rx and the resource indicated for NCR-Fwd backhaul link DL Rx possibly temporally overlap with each other. Further, in this case, there is room for consideration as to which resource to be prioritized between the resource indicated for NCR-MT C-link DL Rx and the resource indicated for NCR-Fwd backhaul link DL Rx.

Thus, in Proposal 1A, an operation related to a temporal overlap between a resource indicated for NCR-MT C-link DL Rx and a resource indicated for NCR-Fwd backhaul link DL Rx in a case where the simultaneous operation of NCR-MT C-link DL Rx and NCR-Fwd backhaul link DL Rx is not supported in NCR will be described.

In the following, executing an operation (for example, reception operation) of NCR-MT C-link DL Rx is sometimes described as executing NCR-MT C-link DL Rx, and executing an operation (for example, reception operation) of NCR-Fwd backhaul link DL Rx is sometimes described as executing NCR-Fwd backhaul link DL Rx.

### <Option 1 of Proposal 1A>

In Option 1 of Proposal 1A, in a case where the simultaneous operation of NCR-MT C-link DL Rx and NCR-Fwd backhaul link DL Rx is not supported in NCR, NCR does not assume that the resources indicated for NCR-MT C-link DL Rx and the resources indicated for NCR-Fwd backhaul link DL Rx temporally overlap with each other. For example, in a case where the simultaneous operation of NCR-MT C-link DL Rx and NCR-Fwd backhaul link DL Rx is not supported in NCR, NCR performs one of the operations of NCR-MT C-link DL Rx and NCR-Fwd backhaul link DL Rx, and does not perform the other operation.

In other words, in a case where the simultaneous operation of NCR-MT C-link DL Rx and NCR-Fwd backhaul link DL Rx is not supported in NCR, the resource indicated for NCR-MT C-link DL Rx and the resource indicated for NCR-Fwd backhaul link DL Rx need not temporally overlap with each other. That is, in this case, the side that indicates the resources (for example, NW (for example, gNB)) may configure the resource for NCR-MT C-link DL Rx and the resource for NCR-Fwd backhaul link DL Rx to resources that do not temporally overlap with each other.

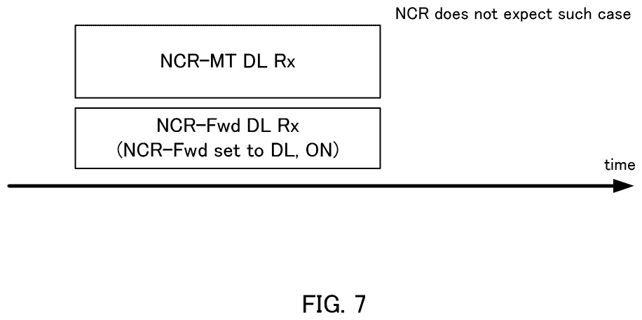

FIG. 7 is a diagram illustrating an example of Option 1 of Proposal 1A. FIG. 7 illustrates an example of Option 1 of Proposal 1A. Note that the horizontal axis in the example of FIG. 7 represents the time axis. Further, “NCR-MT DL Rx” in FIG. 7 represents a resource indicated for NCR-MT C-link DL Rx, and “NCR-Fwd DL Rx” represents a resource indicated for NCR-Fwd backhaul link DL Rx. In FIG. 7, “NCR-MT DL Rx” and “NCR-Fwd DL Rx” overlap with each other in the time direction.

As illustrated in FIG. 7, in Option 1 of Proposal 1A, a case as illustrated in FIG. 7 need not be assumed.

Note that FIG. 7 illustrates a case where two resources completely overlap with each other in the time direction, but the present disclosure is not limited thereto. For example, NCR need not assume a case where two resources partially overlap with each other in the time direction.

By the indication of resources as described in Option 1 of Proposal 1A, in a case where the simultaneous operation of NCR-MT C-link DL Rx and NCR-Fwd backhaul link DL Rx is not supported in NCR, the indication of resources that can ensure the consistency between the indication of the resource and the presence or absence of support is performed, thereby realizing appropriate ON-OFF control of NCR.

### <Option 2 of Proposal 1A>

In Option 2 of Proposal 1A, a case is described in which the resource indicated for NCR-MT C-link DL Rx and the resource indicated for NCR-Fwd backhaul link DL Rx possibly temporally overlap with each other in a case where the simultaneous operation of NCR-MT C-link DL Rx and NCR-Fwd backhaul link DL Rx is not supported in NCR.

That is, in Option 2 of Proposal 1A, NCR may assume that the resource indicated for NCR-MT C-link DL Rx and the resource indicated for NCR-Fwd backhaul link DL Rx temporally overlap. Note that, since NCR does not support the simultaneous operation of NCR-MT C-link DL Rx and NCR-Fwd backhaul link DL Rx, in a case where the resource indicated for NCR-MT C-link DL Rx and the resource indicated for NCR-Fwd backhaul link DL Rx temporally overlap with each other, NCR may perform one of the operations of NCR-MT C-link DL Rx and NCR-Fwd backhaul link DL Rx, and need not perform the other operation.

Further, in the case of Option 2 of Proposal 1A, the resource indicated for NCR-MT C-link DL Rx and the resource indicated for NCR-Fwd backhaul link DL Rx may temporally overlap. That is, in this case, the side that indicates the resources (for example, NW (for example, gNB)) may configure the resource for NCR-MT C-link DL Rx and the resource for NCR-Fwd backhaul link DL Rx to resources that temporally overlap with each other.

Hereinafter, Options 2-1 to 2-3 will be described as three options for Option 2 in Proposal 1A.

### <Option 2-1 of Proposal 1A>

In Option 2-1 of Proposal 1A, which operation, NCR-MT C-link DL Rx or NCR-Fwd backhaul link DL Rx, NCR performs depends on the implementation of NCR. In this case, which operation, NCR-MT C-link DL Rx or NCR-Fwd backhaul link DL Rx, NCR performs may be different for each NCR. For example, in a case where the resource indicated for NCR-MT C-link DL Rx and the resource indicated for NCR-Fwd backhaul link DL Rx temporally overlap with each other, a certain NCR may perform NCR-MT C-link DL Rx in the resource indicated for NCR-MT C-link DL Rx, and another NCR may perform NCR-MT C-link DL Rx in the resource indicated for NCR-Fwd backhaul link DL Rx.

For example, which operation, NCR-MT C-link DL Rx or NCR-Fwd backhaul link DL Rx, to be performed may be configured in advance or may be switched dynamically (or statically). NCR may switch operations between NCR-MT C-link DL Rx and NCR-Fwd backhaul link DL Rx based on an indication received from NW, for example.

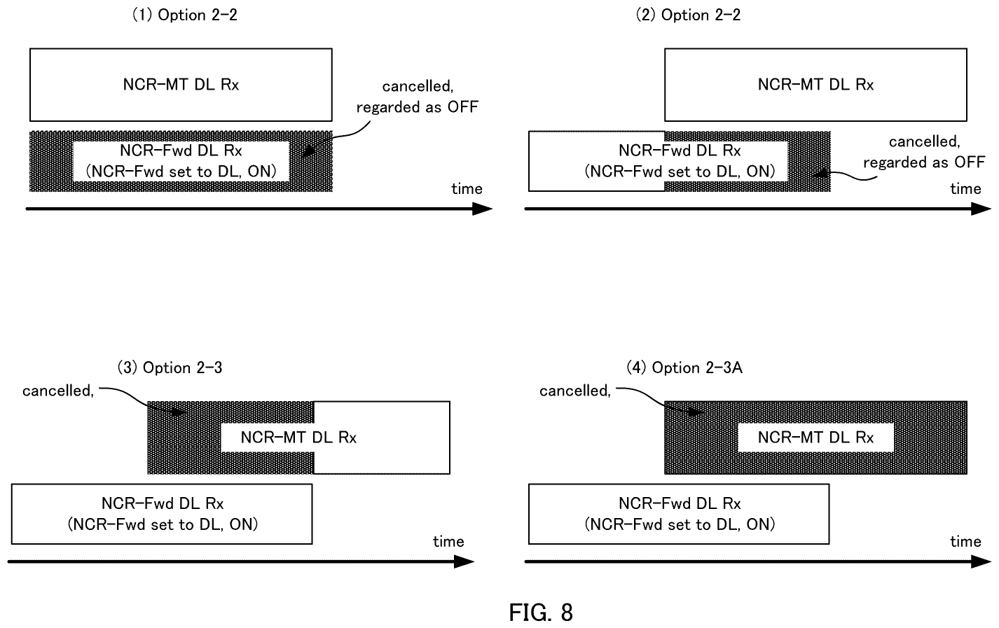

Next, Options 2-2 and 2-3 of Proposal 1A will be described with reference to the drawing. FIG. 8 illustrates examples of Option 2 of Proposal 1A. FIG. 8 illustrates examples of Options 2-2, 2-3, and 2-3A of Proposal 1A. Note that the horizontal axis in each example in FIG. 8 represents the time axis. Further, “NCR-MT DL Rx” in FIG. 8 represents a resource indicated for NCR-MT C-link DL Rx, and “NCR-Fwd DL Rx” represents a resource indicated for NCR-Fwd backhaul link DL Rx.

### <Option 2-2 of Proposal 1A>

In Option 2-2 of Proposal 1A, in a case where the resource indicated for NCR-MT C-link DL Rx and the resource indicated for NCR-Fwd backhaul link DL Rx temporally overlap with each other, NCR performs NCR-MT C-link DL Rx for the resource part that temporally overlaps. In this case, NCR does not need to perform NCR-Fwd backhaul link DL Rx for the resource part that temporally overlaps. That is, here, NCR-Fwd may be regarded as “off” for the time overlapped resource.

Note that, in the following, a resource part that temporally overlaps in a case where the resource indicated for NCR-MT C-link DL Rx and the resource indicated for NCR-Fwd backhaul link DL Rx temporally overlap with each other is sometimes described as “time overlapped resource” in the same manner as in Proposal 1. For example, in Option 2-2 of Proposal 1A, NCR performs the operation of NCR-MT C-link DL Rx for the time overlapped resource.

As illustrated in part (1) of FIG. 8, in Option 2-2, the operation of NCR-Fwd backhaul link DL Rx is not performed (regarded as off) for the time overlapped resource.

Further, as illustrated in part (2) of FIG. 8, in Option 2-2, in a case where the time overlapped resource is partially present, the operation of NCR-Fwd backhaul link DL Rx is not partially performed (regarded as off). Further, in this case, the operation of NCR-Fwd backhaul link DL Rx may be performed in a resource that does not temporally overlap.

### <Option 2-3 of Proposal 1A>

In Option 2-3 of Proposal 1A, NCR performs the operation of NCR-Fwd backhaul link DL Rx for the time overlapped resource. In this case, NCR does not need to perform the operation of NCR-MT C-link DL Rx for the time overlapped resource. In other words, in this case, the operation of NCR-MT C-link DL Rx may be canceled.

As illustrated in part (3) of FIG. 8, in Option 2-3, the operation of NCR-MT C-link DL Rx need not be performed for the time overlapped resource. Further, in this case, the operation of NCR-MT C-link DL Rx may be performed in a resource that does not temporally overlap.

### <Option 2-3A of Proposal 1A>

In Option 2-3 A of Proposal 1A, NCR performs the operation of NCR-Fwd backhaul link DL Rx for the time overlapped resource. This operation is the same as in Option 2-3. In Option 2-3, NCR need not perform the operation of NCR-MT C-link DL Rx for the resource that is indicated for NCR-MT C-link DL Rx and includes the time overlapped resource. In other words, in this case, the operation of NCR-MT C-link DL Rx may be canceled for the entire resource.

As illustrated in part (4) of FIG. 8, in Option 2-3A, the operation of NCR-MT C-link DL Rx need not be performed for the time overlapped resource. Further, in this case, the operation of NCR-MT C-link DL Rx need not be performed even for the resource that does not temporally overlap.

Note that the method (for example, allocation method) for indicating the resource of NCR-MT C-link DL Rx and the resource of NCR-Fwd backhaul link DL Rx is not particularly limited.

For example, NCR-MT C-link DL Rx may be, illustratively, any of PDSCH reception, PDCCH reception, Synchronization signal block (SSB) reception, and CSI-RS reception. Further, the resource for NCR-MT C-link DL Rx may be indicated to NCR in the same manner as the indication for allocating a resource to a UE.

Further, the resource for the NCR-Fwd backhaul link DL Rx may be indicated explicitly or implicitly. For example, the resource of NCR-Fwd backhaul link DL Rx may be explicitly or implicitly indicated to NCR-Fwd that the resource is for “DL.” Alternatively, the resource for NCR-Fwd backhaul link DL Rx may be explicitly or implicitly indicated to be “ON” for NCR-Fwd. For example, the indication of the resource for NCR-Fwd backhaul link DL Rx may correspond to an indication of ON or OFF of NCR-Fwd. Hereinafter, the ON or OFF of NCR-Fwd is sometimes described as “NCR-Fwd ON-OFF.”

Further, each option (each of Options 1, 2-1, 2-2, 2-3, and 2-3A) of Proposal 1A described above may be combined with the method for indicating the resource described above. For example, among the options, the option to be applied may be changed depending on the method for indicating the resource described above.

For example, a case is described in which NCR-MT C-link DL Rx is a PDSCH reception, PDCCH reception, SSB reception, or CSI-RS reception.

For example, in a case where NCR-MT C-link DL Rx is a PDSCH reception, any of the options of Proposal 1A described above may be applied when the PDSCH received by the operation of NCR-MT C-link DL Rx is a dynamic grant PDSCH indicated by DCI or an SPS PDSCH. Further, the options applied to these PDSCHs may be different from each other or may be the same.

For example, in a case where NCR-MT C-link DL Rx is a PDCCH reception, any of the options in Proposal 1A described above may be applied when the PDCCH received by the operation of NCR-MT C-link DL Rx is a PDCCH for a common search space (CSS) or a PDCCH for a UE specific search space (USS). Further, the options applied to these PDCCHs may be different from each other or may be the same.

Further, for example, in a case where NCR-MT C-link DL Rx is a PDCCH reception for a CSS, any of the options of Proposal 1A described above may be applied when the type of CSS of the PDCCH received by the operation of NCR-MT C-link DL Rx is any of type 0/0A/0B/1/1A/2/2A/3. Further, the options applied to these CSS types may be different from one another or may be the same.

Further, for example, in a case where NCR-MT C-link DL Rx is a CSI-RS reception, any of the options in Proposal 1A described above may be applied when the resource of the CSI-RS received by the operation of NCR-MT C-link DL Rx is a resource of a periodic CSI-RS, a resource of a semi-persistent CSI-RS, or a resource of an aperiodic CSI-RS. Further, the options applied to these CSI-RS resources may be different from one another or may be the same.

Further, for example, in a case where NCR-MT C-link DL Rx is a CSI-RS reception, any of the options of Proposal 1A described above may be applied when the resource of the CSI-RS received by the operation of NCR-MT C-link DL Rx is a CSI-RS resource associated with a periodic CSI report, a CSI-RS resource associated with a semi-persistent CSI report, or a CSI-RS resource associated with an aperiodic CSI report. Further, the options applied to these CSI-RS resources may be different from one another or may be the same.

Further, for example, in a case where NCR-MT C-link DL Rx is a CSI-RS reception, any of the options of Proposal 1A described above may be applied when the CSI-RS received by the operation of NCR-MT C-link DL Rx is a CSI-RS for tracking, a CSI-RS for calculating CSI, a CSI-RS for calculating layer 1 Reference Signal Received Power (L1-RSRP) and/or layer 1 Signal to Interference and Noise Ratio (L1-SINR), or a CSI (or CSI-RS) for mobility. Further, the options applied to these CSI-RSs may be different from one another or may be the same.

Next, each option of Proposal 1A in accordance with the indication of the resource of NCR-Fwd backhaul link DL Rx will be described.

For example, any of the options in Proposal 1A described above may be applied in a case where NCR-Fwd backhaul link DL Rx (for example, NCR-Fwd ON-OFF) is explicitly or implicitly indicated. Further, the option to be applied may be different or the same between the case of an explicit indication and the case of an implicit indication.

For example, any of the options in Proposal 1A described above may be applied in a case where NCR-Fwd backhaul link DL Rx (for example, NCR-Fwd ON-OFF) is indicated dynamically or semi-statically. Further, the option to be applied may be different or the same between the case of a dynamic indication and the case of a semi-static indication.

For example, any of the options in Proposal 1A described above may be applied in a case where NCR-Fwd backhaul link DL Rx (for example, NCR-Fwd ON-OFF) is indicated by DCI, MAC CE, or RRC. Further, the option to be applied may be different or the same among the cases of an indication by DCI, an indication by MAC CE, and an indication by

RRC.

At least one of the cases described above for NCR-MT C-link DL Rx and at least one of the cases described above for NCR-Fwd backhaul link DL Rx may be combined. Then, any of the options of Proposal 1A described above may be applied to this combination. Note that, depending on the difference in the combination, the options applied may differ from one another or may be the same.

For example, when the PDSCH received in the operation of NCR-MT C-link DL Rx is a dynamic grant PDSCH, and NCR-Fwd backhaul link DL Rx (for example, NCR-Fwd ON-OFF) is indicated semi-statically, any of the options of Proposal 1A described above may be applied.

As shown in Option 2 of Proposal 1A, preferentially using one of the two resources and not using the other makes it possible to achieve consistency in a case where the simultaneous operation of NCR-MT C-link DL Rx and NCR-Fwd backhaul link DL Rx is not supported in NCR, thereby realizing appropriate ON-OFF control of NCR.

### <Proposal 2>

In Proposal 1 and Proposal 1A described above, as a case where simultaneous operation is not supported in NCR, cases have been described in which simultaneous operation of NCR-MT C-link UL Tx and NCR-Fwd backhaul link UL Tx is not supported, and in which simultaneous operation of NCR-MT C-link DL Rx and NCR-Fwd backhaul link DL Rx is not supported. In Proposal 2, a case where simultaneous operation is supported in NCR will be described.

For a case where the simultaneous operation of a plurality of operations is supported in NCR, there is room for consideration as to whether one operation is associated with an indication related to the other operation. For example, in this case, one operation may be associated with an indication related to the other operation. For example, NCR may start or end one operation based on a specific indication related to the other operation. For example, in a case where the indication related to one operation is a certain specific indication, the other operation may be started, and in a case where the indication related to one operation is another specific indication, the other operation may be ended.

Note that, the case where the simultaneous operation of NCR is supported may be interpreted as a case where NCR has the capability to perform the simultaneous operation, a case where the simultaneous operation is enabled, or a case where the simultaneous operation is configured. Further, the case where the simultaneous operation of NCR is supported may be interpreted as a case where the simultaneous operation is supported in a gNB and/or a UE, which are communication partners of NCR.

As described above, by associating one operation with an indication related to the other operation, there is a possibility that an indication for NCR can be concisely performed and the overhead of signaling can be reduced. Further, by associating one operation with an indication related to the other operation, the control of the NCR can be simplified.

Thus, Proposal 2 describes an exemplary operation in which the ON-OFF of NCR-Fwd backhaul link UL Tx is associated with the indication for NCR-MT C-link UL Tx in a case where the simultaneous operation of NCR-MT C-link UL Tx and NCR-Fwd backhaul link UL Tx is supported.

Performing the operation of NCR-Fwd backhaul link UL Tx is sometimes described as turning NCR-Fwd “ON.” Further, not performing the operation of NCR-Fwd backhaul link UL Tx is sometimes described as turning NCR-Fwd “OFF.” Note that, as another example, turning NCR-Fwd “ON” may correspond to performing at least one of the operation of NCR-Fwd backhaul link UL Tx and the operation of NCR-Fwd backhaul link DL Rx. Further, as another example, turning NCR-Fwd “OFF” may correspond to not performing at least one of the operation of NCR-Fwd backhaul link UL Tx and the operation of NCR-Fwd backhaul link DL Rx.

### <Option 1 of Proposal 2>

In Option 1 of Proposal 2, NCR-Fwd is regarded as “ON” in a case where the transmission of any NCR-MT C-link UL channel (or signal or reference signal) is indicated in the resource indicated for NCR-MT C-link UL Tx. For example, NCR turns NCR-Fwd “ON” when NCR receives an indication to transmit any NCR-MT C-link UL channel (or signal).

Note that, the case where the transmission of any NCR-MT C-link UL channel (or a signal or a reference signal) is indicated may be, for example, a case where any UL channel, UL signal, or reference signal (RS) is indicated in the operation of NCR-MT C-link UL Tx. Further, in the following, the channel (or signal or reference signal) of NCR-MT C-link UL is sometimes simply referred to as an NCR-MT C-link UL signal.

Note that, in Option 1 of Proposal 2, in a case where the transmission of any NCR-MT C-link UL signal is not indicated in the resource indicated for NCR-MT C-link UL Tx, NCR-Fwd may be regarded as “OFF.” Further, in Option 1 of Proposal 2, in a case where no resource is indicated for NCR-MT C-link UL Tx, NCR-Fwd may be regarded as “OFF.” Alternatively, in Option 1 of Proposal 2, the indication to turn NCR-Fwd “OFF” may be provided separately from the indication to turn NCR-Fwd “ON.”

In Option 1 of Proposal 2, the operation of NCR-Fwd is associated with an indication (for example, an indication of a resource or an indication of a signal) related to the operation of NCR-MT, which makes it possible to perform the indication for NCR concisely, reduce signaling overhead, and realize appropriate ON-OFF control of NCR.

### <Option 2 of Proposal 2>

In Option 2 of Proposal 2, NCR-Fwd is regarded as “ON” only when the transmission of a specific NCR-MT C-link UL signal is indicated in the resource indicated for NCR-MT C-link UL Tx. For example, when NCR receives an indication to transmit a specific NCR-MT C-link UL signal, NCR turns NCR-Fwd “ON.”

Note that, the case where the transmission of a specific NCR-MT C-link UL signal is indicated may be, for example, a case where a specific UL channel, UL signal, or reference signal (RS) is indicated in the operation of NCR-MT C-link UL Tx.

Note that, in Option 2 of Proposal 2, in a case where the transmission of a specific NCR-MT C-link UL signal is not indicated in the resource indicated for NCR-MT C-link UL Tx, NCR-Fwd may be regarded as “OFF.”

Note that, the case where the transmission of a specific NCR-MT C-link UL signal is not indicated may be a case where the transmission of an NCR-MT C-link UL signal other than the specific NCR-MT C-link UL signal is indicated, a case where the transmission of an NCR-MT C-link UL signal is not indicated, or a case where a resource is not indicated for NCR-MT C-link UL Tx.

Alternatively, in Option 2 of Proposal 2, the indication to turn NCR-Fwd “OFF” may be provided separately from the indication to turn NCR-Fwd “ON.”

For example, in Option 2 of Proposal 2, the case where the transmission of a specific NCR-MT C-link UL signal is indicated is not particularly limited. For example, the case may be at least one of the following.
Case where the signal transmitted in NCR-MT C-link UL Tx is at least one of a cell-specific channel, a cell-specific signal, and a cell-specific reference signal
Case where the signal transmitted in NCR-MT C-link UL Tx is a PUSCH, PUCCH, SRS, or PRACH
Case where the signal transmitted in NCR-MT C-link UL Tx is a PUSCH, and is a dynamic grant PUSCH indicated by DCI, a type 1 configured grant PUSCH, or a type 2 configured grant PUSCH
Case where the signal transmitted in NCR-MT C-link UL Tx is a PUCCH, and is a dynamic PUCCH indicated by DCI or a semi-static PUCCH configured by RRC
Case where the signal transmitted in NCR-MT C-link UL Tx is a PUCCH, and a PUCCH for SR, or a PUCCH for CSI, or a PUCCH for HARQ
Case where the signal transmitted in NCR-MT C-link UL Tx is a PUCCH for CSI, and a PUCCH for periodic CSI, or a PUCCH for semi-persistent CSI, or a PUCCH for aperiodic CSI
Case where the signal transmitted in NCR-MT C-link UL Tx is an SRS, and a periodic SRS, a semi-persistent SRS, or an aperiodic SRS
Case where the signal transmitted in NCR-MT C-link UL Tx is an SRS, and the usage of the SRS is set to “codebook,” “non-codebook,” “beam management,” or “antenna switching”
Case where the signal transmitted in NCR-MT C-link UL Tx is a PRACH, and a RACH triggered by a PDCCH order or a RACH triggered by a MAC layer or RRC layer

Note that, in Option 2 of Proposal 2, NCR-Fwd may be regarded as “ON” in a case where the transmission of a specific NCR-MT C-link UL signal (for example, the transmission of a first signal) is indicated, and NCR-Fwd may be regarded as “OFF” in a case where the transmission of a specific NCR-MT C-link UL signal different from the transmission of the first signal (for example, the transmission of a second signal) is indicated.

In Option 2 of Proposal 2, the operation of NCR-Fwd is associated with an indication (for example, a resource indication or a signal indication) related to the operation of NCR-MT, which makes it possible to perform the indication for NCR concisely, reduce signaling overhead, and realize appropriate ON-OFF control of NCR.

### <Option 3 of Proposal 2>

In Option 3 of Proposal 2, the ON or OFF of NCR-Fwd may be independent of the indication for NCR-MT C-link UL Tx. For example, the ON or OFF of NCR-Fwd may be indicated independently of the indication in NCR-MT C-link UL Tx.

Note that the ON of NCR-Fwd and the OFF of NCR-Fwd may be independent of each other. For example, NCR may perform the control of turning NCR-Fwd ON in accordance with Option 1 or Option 2 of Proposal 2 described above, and the control of turning NCR-Fwd OFF based on an indication individually received.

In Option 3 of Proposal 2, the operation of NCR-Fwd is indicated independently of the indication related to the operation of NCR-MT (for example, an indication of a resource or an indication of a signal). Thus, it is possible to flexibly perform an indication to NCR, and it is possible to improve the degree of freedom in the control of NCR, thereby realizing appropriate ON-OFF control of NCR.

### <Proposal 2A>

In Proposal 2A, a case where simultaneous operation is supported in NCR will be described in the same manner as in Proposal 2.

As described in Proposal 2, for a case where the simultaneous operation of a plurality of operations is supported in NCR, there is room for consideration as to whether one operation is associated with an indication related to the other operation. By associating one operation with an indication related to the other operation, there is a possibility that an indication for NCR can be concisely performed and the overhead of signaling can be reduced.

Further, by associating one operation with an indication related to the other operation, the control of the NCR can be simplified.

In Proposal 2, an operation example in which the ON-OFF of NCR-Fwd backhaul link UL Tx is associated with the indication for NCR-MT C-link UL Tx in a case where the simultaneous operation of NCR-MT C-link UL Tx and NCR-Fwd backhaul link UL Tx is supported has been described as an example.

In Proposal 2A, as an example different from Proposal 2, an operation example in which the ON-OFF of NCR-Fwd backhaul link DL Rx is associated with the indication for NCR-MT C-link DL Rx in a case where the simultaneous operation of NCR-MT C-link DL Rx and NCR-Fwd backhaul link DL Rx is supported is described.

Performing the operation of NCR-Fwd backhaul link DL Rx is sometimes described as turning NCR-Fwd “ON.” Further, not performing the operation of the NCR-Fwd backhaul link DL Rx is sometimes described as turning NCR-Fwd “OFF.” Note that, as another example, turning NCR-Fwd “ON” may correspond to performing at least one of the operation of NCR-Fwd backhaul link UL Tx and the operation of NCR-Fwd backhaul link DL Rx. Further, as another example, turning NCR-Fwd “OFF” may correspond to not performing at least one of the operation of NCR-Fwd backhaul link UL Tx and the operation of NCR-Fwd backhaul link DL Rx.

### <Option 1 of Proposal 2A>

In Option 1 of Proposal 2, NCR-Fwd is regarded as “ON” in a case where the reception of any NCR-MT C-link DL channel (or signal or reference signal) is indicated in the resource indicated for NCR-MT C-link DL Rx. For example, NCR turns NCR-Fwd “ON” when NCR receives an indication to transmit any NCR-MT C-link DL channel (or signal).

Note that, the case where the transmission of any NCR-MT C-link DL channel (or signal or reference signal) is indicated may be, for example, a case where any DL channel, DL signal, or reference signal (RS) is indicated in the operation of NCR-MT C-link DL Rx. Further, in the following, the channel (or signal or reference signal) of NCR-MT C-link DL is sometimes simply referred to as an NCR-MT C-link DL signal.

Note that, in Option 1 of Proposal 2A, in a case where the reception of any NCR-MT C-link DL signal is not indicated in the resource indicated for NCR-MT C-link DL Rx, NCR-Fwd may be regarded as “OFF.” Further, in Option 1 of Proposal 2A, in a case where no resource is indicated for NCR-MT C-link DL Rx, NCR-Fwd may be regarded as “OFF.” Alternatively, in Option 1 of Proposal 2A, the indication to turn NCR-Fwd “OFF” may be provided separately from the indication to turn NCR-Fwd “ON.”

In Option 1 of Proposal 2A, the operation of NCR-Fwd is associated with an indication (for example, a resource indication or a signal indication) related to the operation of NCR-MT, which makes it possible to perform the indication for NCR concisely, reduce signaling overhead, and realize appropriate ON-OFF control of NCR.

### <Option 2 of Proposal 2A>

In Option 2 of Proposal 2A, NCR-Fwd is regarded as “ON” only when the reception of a signal for a specific NCR-MT C-link DL is indicated in the resource indicated for NCR-MT C-link DL Rx. For example, when NCR receives an indication to receive a specific NCR-MT C-link DL signal, NCR turns NCR-Fwd “ON.”

Note that, the case where the transmission of a specific NCR-MT C-link DL signal is indicated may be, for example, a case where a specific DL channel, DL signal, or reference signal (RS) is indicated in the operation of NCR-MT C-link DL Rx.

Note that, in Option 2 of Proposal 2A, in a case where the reception of a specific NCR-MT C-link DL signal is not indicated in the resource indicated for NCR-MT C-link DL Rx, NCR-Fwd may be regarded as “OFF.”

Note that, the case where the reception of a specific NCR-MT C-link DL signal is not indicated may be a case where the reception of an NCR-MT C-link DL signal other than the specific NCR-MT C-link DL signal is indicated, a case where the reception of an NCR-MT C-link DL signal is not indicated, or a case where a resource is not indicated for NCR-MT C-link UL Tx.

Alternatively, in Option 2 of Proposal 2A, the indication to turn NCR-Fwd “OFF” may be provided separately from the indication to turn NCR-Fwd “ON.”

For example, in Option 2 of Proposal 2A, the case where the reception of a specific NCR-MT C-link DL signal is indicated is not particularly limited. For example, the case may be at least one of the following.
Case where the signal received in NCR-MT C-link DL Rx is at least one of a cell-specific channel, a cell-specific signal, and a cell-specific reference signal
Case where the signal received in NCR-MT C-link DL Rx is a PDSCH, PDCCH, or CSI-RS
Case where the signal received in NCR-MT C-link DL Rx is a PDSCH and is a dynamic PDSCH or an SPS PDSCH indicated by DCI
Case where the signal received in NCR-MT C-link DL Rx is a PDCCH, and a PDCCH for a common search space (CSS) or a PDCCH for a UE specific search space (USS)
Case where the signal received in NCR-MT C-link DL Rx is a PDCCH for a CSS, and the type of the CSS of the PDCCH is any of type0/0A/0B/1/1A/2/2A/3
Case where the signal received in NCR-MT C-link DL Rx is a CSI-RS, and the resource of the CSI-RS is a resource of a periodic CSI-RS, a resource of a semi-persistent CSI-RS, or a resource of an aperiodic CSI-RS
Case where the signal received in NCR-MT C-link DL Rx is a CSI-RS, and a CSI-RS resource associated with a periodic CSI report, a CSI-RS resource associated with a semi-persistent CSI report, or a CSI-RS resource associated with an aperiodic CSI report
Case where the signal received in NCR-MT C-link DL Rx is a CSI-RS, and a CSI-RS for tracking, or a CSI-RS for the calculation of CSI, or a CSI-RS for the calculation of L1-RSRP and/or L1-SINR, or CSI (or CSI-RS) for mobility

Note that, in Option 2 of Proposal 2A, NCR-Fwd may be regarded as “ON” in a case where the reception of a specific NCR-MT C-link DL signal (for example, the reception of a first signal) is indicated, and NCR-Fwd may be regarded as “OFF” in a case where the reception of a specific NCR-MT C-link DL signal different from the reception of the first signal (for example, the reception of a second signal) is indicated.

In Option 2 of Proposal 2A, the operation of NCR-Fwd is associated with an indication (for example, an indication of a resource or an indication of a signal) related to the operation of NCR-MT, thereby making it possible to perform the indication for NCR concisely, to reduce signaling overhead, and to realize appropriate ON-OFF control of NCR.

### <Option 3 of Proposal 2A>

In Option 3 of Proposal 2A, the ON or OFF of NCR-Fwd may be independent of the indication in NCR-MT C-link DL Rx. For example, the ON or OFF of NCR-Fwd may be indicated independently of the indication in NCR-MT C-link UDL Rx.

Note that the ON of NCR-Fwd and the OFF of NCR-Fwd may be independent of each other. For example, NCR may perform the control of turning NCR-Fwd ON in accordance with Option 1 or Option 2 of Proposal 2A described above, and the control of turning NCR-Fwd OFF based on an indication individually received.

In Option 3 of Proposal 2A, the operation of NCR-Fwd is indicated independently of the indication related to the operation of NCR-MT (for example, an indication of a resource or an indication of a signal). Thus, it is possible to flexibly perform an indication to NCR, and it is possible to improve the degree of freedom in the control of NCR, thereby realizing appropriate ON-OFF control of NCR.

### <Proposal 3>

One option for the ON-OFF control of NCR-Fwd is that the resource of a cell-specific signal configured for NCR-MT is regarded as “ON” of NCR-Fwd. This is because the cell-specific signal is a signal also necessary for a normal UE and needs to be transferred between the normal UE and the gNB. The normal UE may be herein a UE that is not an NCR (a UE that does not have a function as an NCR), for example. In other words, since the cell-specific signal is a signal necessary for both an NCR and a UE that is not an NCR, the NCR turns NCR-Fwd “ON” in order to receive the cell-specific signal configured for NCR-MT from gNB and to transfer the cell-specific signal from the gNB to a UE.

In the case of SSBs, however, it is conceivable that only some of SSBs are transferred by NCR, and the remaining SSBs are directly transmitted from gNB to UE without being transferred by NCR. The resources of SSBs that do not require to be transferred by NCR may be regarded as “OFF.” In other words, the resources of SSBs directly transmitted from gNB to UE are resources that does not require to be transferred, and thus NCR may turn NCR-Fwd “OFF” for the resource of a signal that does not require to be transferred from gNB to UE.

Note that a resource (or a signal, or a channel) being regarded as “OFF” may correspond to that NCR-Fwd may be turned “OFF” for the resource, or that the transfer is unnecessary for the resource. Further, a resource being regarded as “ON” may correspond to turning NCR-Fwd “ON” for the resource or performing transfer for the resource.

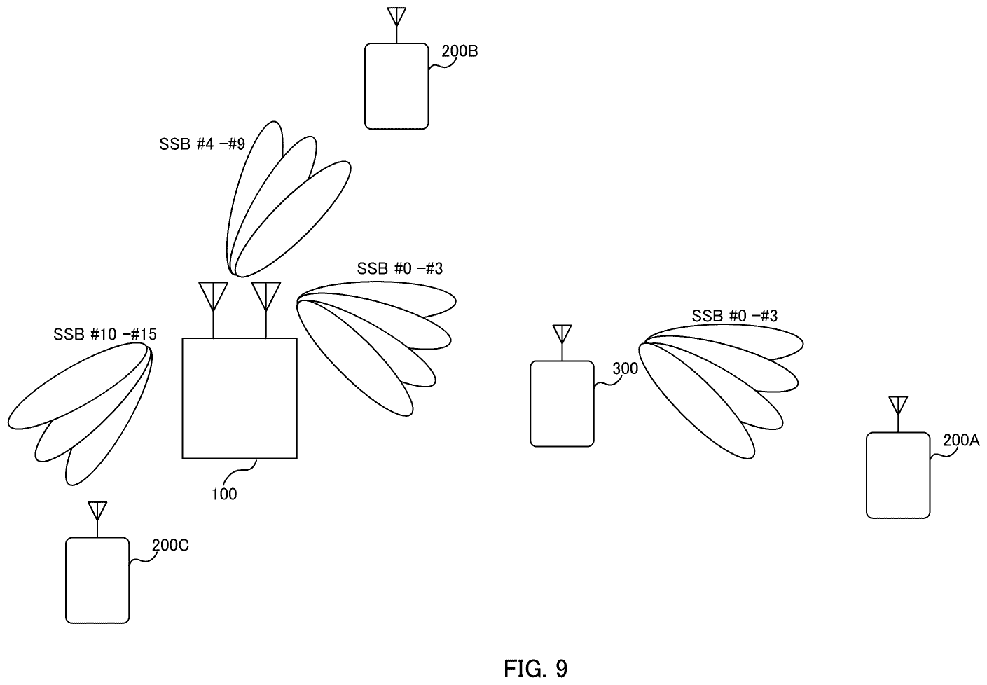

FIG. 9 illustrates exemplary SSB resources. FIG. 9 illustrates gNB 100, NCR 300, and three UEs 200 (UEs 200A, 200B, and 200C). FIG. 9 illustrates SSBs of SSB #0 to SSB #15 transmitted by gNB 100.

In the example of FIG. 9, SSB #0 to SSB #3 of SSB #0 to SSB #15 transmitted by gNB 100 are transferred by NCR 300 and received by UE 200A. SSB #4 to SSB #15 are SSBs that are transmitted directly to UE 200B or UE 200C. In this case, NCR 300 does not need to transfer SSB #4 to SSB #15.

However, there is a possibility that NCR cannot determine whether the SSB resource is an SSB resource that needs to be transferred or an SSB resource that does not need to be transferred. In this case, for example, in a case where NCR-Fwd is turned ON to transfer an SSB resource that does not need to be transferred, the power consumption in the NCR increases due to the unnecessary transfer. Further, interference is possibly caused by performing unnecessary transfer.

Further, for example, in a case where NCR-Fwd is not turned ON (the OFF state is maintained) for an SSB resource to be transferred, the communication quality between gNB and UE possibly deteriorates due to the SSB resource to be transferred not being transferred.

Thus, in Proposal 3, an operation is described in which an SSB that needs to be transferred by NCR is indicated, and the resource of the indicated SSB received by NCR-MT is regarded as “ON” of NCR-Fwd. Next, a method for indicating an SSB that needs to be transferred by NCR will be described.

Note that, in the above, the control of “ON” or “OFF” of NCR-Fwd for the SSB resource has been described, but the present disclosure is not limited thereto. Not only the SSB resource, but also a cell-specific CSI-RS resource, a cell-specific PDCCH, and a cell-specific PDSCH possibly cause the same problem as the SSB resource. In this case, NCR-Fwd performs the transfer of some of CSI-RS resources, some of PDCCHs, or some of PDSCHs of NCR-MT in the same manner as in the example described above for SSBs. NCR-Fwd executing the transfer is regarded as NCR-Fwd being “ON.” Note that, in this case, NCR-Fwd does not need to perform the transfer of the remaining CSI-RS resources of NCR-MT when performing the transfer of some of the CSI-RS resources of NCR-MT, in the same manner as in the example described above for SSBs. NCR-Fwd not performing the transfer may be regarded as NCR-Fwd being “OFF.”

Hereinafter, SSB resources, CSI-RS resources, PUSCHs, and PUCCHs are each described.

### <Proposal 3-1>

In Proposal 3-1, an example of the relationship between an SSB resource and ON-OFF control of NCR-Fwd is described. For example, in Proposal 3-1, the resource of the SSB received by NCR-MT is regarded as “ON.” In other words, in Proposal 3-1, NCR-Fwd is turned “ON” for the resource of the SSB received by NCR-MT.

For example, the following options are described for the resource regarded as “ON.”

### <Option 1 of Proposal 3-1>

In Option 1 of Proposal 3-1, all resources of SSBs are regarded as “ON.” The all resources of SSBs may be, for example, all resources of SSBs received by NCR-MT. In this case, NCR executes transfer for all SSBs. The transfer may be executed by NCR-Fwd.

Option 1 of Proposal 3-1 may be configured by, for example, an NW (for example, gNB), or may be enabled by an NW (for example, gNB). In a case of being configured by the NW or enabled by the NW, all SSB resources are regarded as “ON.” In this case, NCR executes the transfer for all SSBs.

### <Option 2 of Proposal 3-1>

In Option 2 of Proposal 3-1, the NW indicates a set of SSBs. The set of SSBs indicated includes an indication of one or more SSBs or resources of SSBs. The resource of the SSB indicated by the NW is regarded as “ON.” In this case, NCR executes the transfer of the SSB indicated by the NW. Note that, in this case, a resource of an SSB that is not indicated by the NW may be regarded as “OFF.” Further, NCR need not perform the transfer of the SSB that is not indicated by the NW.

Alternatively, the resource of the SSB indicated by the NW may be regarded as “OFF.” In this case, NCR need not execute the transfer of the SSB indicated by the NW. Further, in this case, a resource of an SSB that is not indicated by the NW may be regarded as “ON.” NCR may execute the transfer of the SSB that is not indicated by the NW.

Note that the method in which the NW indicates SSBs is not limited. For example, a method such as the following Option 2-1 or Option 2-2 may be applied.

### <Option 2-1 of Proposal 3-1>

In Option 2-1 of Proposal 3-1, the sequence of SSB indices is indicated by the NW. For example, the indication of this sequence may be performed by the side control information. For example, the indication of this sequence may be performed by at least one of RRC, MAC CE, and DCI.

### <Option 2-2 of Proposal 3-1>

In Option 2-2 of Proposal 3-1, the bitmap of SSBs is indicated by the NW. For example, the indication of this bitmap may be performed by the side control information. For example, the indication of this bitmap may be performed by at least one of RRC, MAC CE, and DCI.

For example, each bit of the bitmap may correspond to one SSB. For example, in a case where the bit of the bitmap is set to “0,” the SSB corresponding to the bit may be regarded as “ON.” In this case, NCR may execute the transfer of the SSB corresponding to the bit set to “0.” On the other hand, for example, in a case where the bit of the bitmap is set to “1,” the SSB corresponding to the bit may be regarded as “OFF.” In this case, NCR need not execute the transfer of the SSB corresponding to the bit set to “1.”

Note that the relationship between “0” and “1” of the bit and “ON” and “OFF” for the SSB corresponding to the bit may be interchanged.

Note that each bit of the bitmap may correspond to a group of SSBs. Here, the group of SSBs may include one or more SSBs. The method of SSB grouping is not particularly limited. The grouping of SSBs may be, for example, predefined or configured.

For example, one group of SSBs may include N SSBs (N is an integer of 1 or more). SSBs with SSB indices #0 to #N−1 may be included in the first group. Similarly, SSBs with SSB indices #N to #2N−1 may be included in the second group. Similarly, SSBs with SSB indices #kN to #kN+N−1 (k is an integer of 0 or more) may be included in the (k+1)th group.

### <Proposal 3-2>

In Proposal 3-2, an example of the relationship between a resource of a CSI-RS and ON-OFF control of NCR-Fwd is described. In Proposal 3-2, the resource of the CSI-RS received by NCR-MT is regarded as “ON.” In other words, in Proposal 3-2, NCR-Fwd is turned “ON” for the resource of the CSI-RS received by NCR-MT.

For example, Proposal 3-2 may be applied only to a resource of a periodic CSI-RS. In other words, Proposal 3-2 need not be applied to a resource that is not a resource of a periodic CSI-RS.

Further, Proposal 3-2 may be applied only to a resource of a semi-persistent CSI-RS. Further, Proposal 3-2 may be applied only to both a resource of a periodic CSI-RS and a resource of a semi-persistent CSI-RS.

Further, Proposal 3-2 may be applied only to a CSI-RS resource associated with a periodic CSI report. Further, Proposal 3-2 may be applied only to a CSI-RS resource associated with a semi-persistent CSI report. Further, Proposal 3-2 may be applied only to a CSI-RS resource associated with an aperiodic CSI report. Further, Proposal 3-2 may be applied only to a combination of at least two of a CSI-RS resource associated with a periodic CSI report, a CSI-RS resource associated with a semi-persistent CSI report, and a CSI-RS resource associated with an aperiodic CSI report.

Further, Proposal 3-2 may be applied only to a CSI-RS for tracking. Further, Proposal 3-2 may be applied only to a CSI-RS for the calculation of CSI. Further, Proposal 3-2 may be applied only to a CSI-RS for the calculation of L1-RSRP and/or L1-SINR. Further, Proposal 3-2 may be applied only to CSI (or CSI-RS) for mobility. Further,

Proposal 3-2 may be applied only to a combination of at least two of a CSI-RS for tracking, a CSI-RS for CSI calculation, a CSI-RS for L1-RSRP and/or L1-SINR calculation, and CSI (or CSI-RS) for mobility.

Note that, for example, the following options will be described for a resource of a CSI-RS that is regarded as “ON.”

### <Option 1 of Proposal 3-2>

In Option 1 of Proposal 3-2, all resources of CSI-RSs and/or all sets of resources of CSI-RSs are regarded as “ON.” The all resources of CSI-RSs and/or all sets of resources of CSI-RSs may be, for example, all resources of CSI-RSs and/or all sets of resources of all CSI-RSs received by NCR-MT. In this case, NCR performs transfer for all resources of CSI-RSs and/or all sets of resources of CSI-RSs. The transfer may be executed by NCR-Fwd.

For example, Option 1 of Proposal 3-2 may be configured by an NW (for example, gNB) or may be enabled by an NW (for example, gNB). In a case of being configured by the NW or enabled by the NW, all resources of CSI-RSs are regarded as “ON.” In this case, NCR executes the transfer for all CSI-RSs.

### <Option 2 of Proposal 3-2>

In Option 2 of Proposal 3-2, the NW indicates a set of resources of CSI-RSs or a set consisting of sets of resources of CSI-RSs. The indicated set of resources of CSI-RSs may include one or more resources of CSI-RSs. Further, the indicated set consisting of sets of resources of CSI-RSs may include at least one set of CSI-RS resources.

The resource of the CSI-RS or the set of resources of CSI-RSs indicated by the NW is regarded as “ON.” In this case, NCR performs the transfer of the CSI-RS (for example, the resource of the CSI-RS or the set of resources of CSI-RSs) indicated by the NW. Note that, in this case, a resource of a CSI-RS or a set of resources of CSI-RSs that is not indicated by the NW may be regarded as “OFF.” NCR need not perform the transfer of the CSI-RS that is not indicated by the NW.

Alternatively, the resource of the CSI-RS or the set of resources of CSI-RSs indicated by the NW may be regarded as “OFF.” In this case, NCR need not perform the transfer of the CSI-RS indicated by the NW. Further, in this case, a resource of a CSI-RS or a set of resources of CSI-RSs that is not indicated by the NW may be regarded as “ON.” NCR may perform the transfer of the CSI-RS that is not indicated by the NW.

Note that the method in which the NW indicates a resource of a CSI-RS or a set of resources of CSI-RSs is not limited. For example, a method such as the following Option 2-1 or Option 2-2 may be applied.

### <Option 2-1 of Proposal 3-2>

In Option 2-1 of Proposal 3-2, the sequence of one or more indices of CSI-RS resources is indicated by the NW. Alternatively, a sequence of indices of one or more sets of CSI-RS resources is indicated by the NW. For example, the indication of this sequence may be performed by the side control information. The indication of this sequence may be performed by at least one of RRC, MAC CE, and DCI. For example, the side control information including the indication of the sequence may be indicated by at least one of RRC, MAC CE, and DCI.

### <Option 2-2 of Proposal 3-2>

In Option 2-2 of Proposal 3-2, a bitmap of CSI-RS resources or a set of CSI-RS resources is indicated by the NW. For example, the indication of this bitmap may be performed by the side control information. The indication of this bitmap may be performed by at least one of RRC, MAC CE, and DCI. For example, the side control information including the indication of the bitmap may be indicated by at least one of RRC, MAC CE, and DCI.

For example, each bit of the bitmap indicated by NW may correspond to one CSI-RS resource or one set of CSI-RS resources. For example, in a case where the bit of the bitmap is set to “0,” the resource of the CSI-RS or the set of resources of CSI-RSs corresponding to the bit may be regarded as “ON.” In this case, NCR may execute the transfer of the CSI-RS corresponding to the bit set to “0.” On the other hand, for example, in a case where the bit of the bitmap is set to “1,” the resource of the CSI-RS or the set of resources of CSI-RSs corresponding to the bit may be regarded as “OFF.” In this case, NCR need not execute the transfer of the CSI-RS corresponding to the bit set to “1.”

Note that the relationship between “0” and “1” of the bit and “ON” and “OFF” for the resource of the CSI-RS or the set of resources of CSI-RSs corresponding to the bit may be interchanged.

Note that any of the following variations may be applied to Option 2-2 of Proposal 3-2.

### <Variation 1>

The NW may indicate one set of resources of CSI-RSs. Further, the bitmap may correspond to CSI-RS resources included in the one set of resources of CSI-RSs. This bitmap may be indicated by, for example, the NW.

### <Variation 2>

The NW may indicate a plurality of sets of resources of CSI-RSs. Further, the bitmap may correspond to CSI-RS resources included in the plurality sets of resources of CSI-RSs. This bitmap may be indicated by, for example, the NW.

### <Variation 3>

The bitmap may correspond to CSI-RS resources included in all sets of CSI-RS resources.

### <Variation 4>

Each bit of the bitmap may correspond to a group of CSI-RS resources. Alternatively, each bit of the bitmap may correspond to a group of sets of CSI-RSs resources. Here, the group of CSI-RS resources may include one or more CSI-RS resources. Further, the group of sets of CSI-RS resources may include one or more sets of CSI-RS resources. The method of grouping is not particularly limited. The grouping of CSI-RS resources or sets of CSI-RS resources may be, for example, predefined or configured.

For example, one group of CSI-RS resources may include N CSI-RS resources (N is an integer of 1 or more). Then, CSI-RS resources corresponding to the lower N indices (for example, #0 to #N−1) of the CSI-RS resources may be included in the first group. Similarly, CSI-RS resources corresponding to the second lower N indices (for example, #N to #2N-1) of the CSI-RSs may be included in the second group.

### <Proposal 3-3>

In Proposal 3-3, an example of the relationship between a cell-specific PDCCH and ON-OFF control of NCR-Fwd is described. Note that the cell-specific PDCCH may correspond to, for example, a PDCCH for a CSS. Further, in the following, the resource of the cell-specific PDCCH is sometimes abbreviated as a cell-specific PDCCH resource. In Proposal 3-3, the resource of the cell-specific PDCCH received by NCR-MT is regarded as “ON.” In other words, in Proposal 3-3, NCR-Fwd is turned “ON” for the resource of the cell-specific PDCCH received by NCR-MT.

Note that Proposal 3-3 may be applied to at least one of type 0/0A/0B/1/1A/2/2A/3 CSSs.

Note that, for example, the following options are described for the cell-specific PDCCH resource that is regarded as “ON.”

### <Option 1 of Proposal 3-3>

In Option 1 of Proposal 3-3, all cell-specific PDCCH resources are regarded as “ON.” The all cell-specific PDCCH resources may be, for example, all cell-specific PDCCH resources received by NCR-MT. In this case, NCR executes transfer for all cell-specific PDCCHs. The transfer may be executed by NCR-Fwd.

Option 1 of Proposal 3-3 may be configured by, for example, an NW (for example, gNB), or may be enabled by an NW (for example, gNB). In a case of being configured by the NW or being enabled by the NW, all cell-specific PDCCH resources are regarded as “ON.” In this case, NCR executes the transfer for all cell-specific PDCCHs.

### <Option 2 of Proposal 3-3>

In Option 2 of Proposal 3-3, the NW indicates a set of cell-specific PDCCHs. The set of cell-specific PDCCHs indicated includes an indication of one or more cell-specific PDCCHs or resources of cell-specific PDCCHs. The cell-specific PDCCH resources indicated by the NW are regarded as “ON.” In this case, NCR executes the transfer of the cell-specific PDCCHs indicated by the NW. Note that, in this case, a cell-specific PDCCH resource that is not indicated by the NW may be regarded as “OFF.” Further, NCR need not perform the transfer of the cell-specific PDCCH that is not indicated by the NW.

Note that, alternatively, the cell-specific PDCCH resources indicated by the NW may be regarded as “OFF.” In this case, NCR need not perform the transfer of the cell-specific PDCCH indicated by the NW. Further, in this case, a cell-specific PDCCH resource that is not indicated by the NW may be regarded as “ON.” Furthermore, NCR may perform the transfer of the cell-specific PDCCH that is not indicated by the NW.

Note that the method in which the NW indicates a cell-specific PDCCH resource is not limited. For example, a method such as the following Options 2-1 to 2-5 may be applied.

### <Option 2-1 of Proposal 3-3>

In Option 2-1 of Proposal 3-3, the indication is performed for each CSS type. That is, the indication is made for each of type 0/0A/B/1/1A/2/2A/3 CSSs. For example, for a certain CSS type, the NW may indicate whether the CSS resource is regarded as “ON” and is transferred by NCR. For example, this indication may mean that the CSS resource is regarded as “ON” and is transferred by NCR, or that the CSS resource is not regarded as “ON” and is not transferred by the NCR. Note that the CSS resource may be considered as an example of the cell-specific PDCCH resource described above.

### <Option 2-2 of Proposal 3-3>

In Option 2-2 of Proposal 3-3, the indication is performed for each search space. For example, for a certain search space, the NW may indicate whether the resource of the search space is regarded as “ON” and is transferred by NCR. For example, this indication may mean that the resource of the search space is regarded as “ON” and is transferred by NCR, or that the resource of the search space is not regarded as “ON” and is not transferred by NCR. Note that the resource of the search space may be considered as an example of the cell-specific PDCCH resource described above.

### <Option 2-3 of Proposal 3-3>

In Option 2-3 of Proposal 3-3, the indication is performed for each CORESER. For example, for a certain CORESET, the NW may indicate whether the resource of the PDCCH and/or the search space associated with the CORESET is regarded as “ON” and is transferred by NCR. For example, the indication may mean that the resource of the PDCCH and/or the search space associated with the CORESET is regarded as “ON” and is transferred by NCR, or that the resource of the PDCCH and/or the search space associated with the CORESET is not regarded as “ON” and is not transferred by the NCR. Note that the resource of the PDCCH and/or the search space associated with the CORESET may be considered as an example of the cell-specific PDCCH resource described above.

### <Option 2-4 of Proposal 3-3>

In Option 2-4 of Proposal 3-3, the indication may be performed for each monitoring occasion for a PDCCH. For example, for a certain monitoring occasion for a PDCCH, the NW may indicate whether the resource of the monitoring occasion for the PDCCH is regarded as “ON” and is transferred by NCR. For example, this indication may mean that the resource of the monitoring occasion for the PDCCH is regarded as “ON” and is transferred by NCR, or that the resource of the monitoring occasion for the PDCCH is not regarded as “ON” and is not transferred by NCR.

### <Option 2-5 of Proposal 3-3>

In Option 2-5 of Proposal 3-3, the indication may be performed for each transmission configuration indicator (TCI) state of a PDCCH and/or for each Quasi Co Location (QCL) reference reference signal (RS). For example, for a certain TCI state and/or QCL reference RS, the NW may indicate whether the resource of the PDCCH associated with a QCL including the QCL reference RS or the resource of the PDCCH associated with the TCI state is regarded as “ON” and is transferred by NCR. For example, the indication may mean that the resource of the PDCCH associated with the QCL including the QCL reference RS or the resource of the PDCCH associated with the TCI state is regarded as “ON” and is transferred by NCR, or that the resource of the PDCCH associated with the QCL including the QCL reference RS or the resource of the PDCCH associated with the TCI state is not regarded as “ON” and is not transferred by the NCR.

### <Proposal 3-4>

In Proposal 3-4, an example of the relationship between a cell-specific PDSCH and ON-OFF control of NCR-Fwd will be described. Note that the cell-specific PDSCH may correspond to, for example, a PDSCH scheduled by a cell-specific PDCCH. Further, in the following, the resource of the cell-specific PDSCH may be abbreviated as a cell-specific PDSCH resource. In Proposal 3-4, the cell-specific PDSCH resource received by NCR-MT is regarded as “ON.” In other words, in Proposal 3-4, NCR-Fwd is turned “ON” for the cell-specific PDSCH resource received by NCR-MT.

Note that, Proposal 3-4 may be applied to a PDSCH scheduled by a PDCCH of at least one of type 0/0A/0B/1/1A/2/2A/3 CSSs.

Note that, for example, the following options will be described for the cell-specific PDSCH resource that is regarded as “ON.”

### <Option 1 of Proposal 3-4>

In Option 1 of Proposal 3-4, all cell-specific PDSCH resources are regarded as “ON.” The all cell-specific PDSCH resources may be, for example, all cell-specific PDSCH resources received by NCR-MT. In this case, NCR executes transfer for all cell-specific PDSCHs. The transfer may be executed by NCR-Fwd.

For example, Option 1 of Proposal 3-4 may be configured by an NW (for example, gNB) or may be enabled by an NW (for example, gNB). In a case of being configured by the NW or enabled by the NW, all cell-specific PDSCH resources are regarded as “ON.” In this case, NCR executes the transfer for all cell-specific PDSCHs.

### <Option 2 of Proposal 3-4>

In Option 2 of Proposal 3-4, the NW indicates a set of cell-specific PDSCHs. The set of cell-specific PDSCHs indicated includes an indication of one or more cell-specific PDSCHs or resources of cell-specific PDSCHs. The cell-specific PDSCH resource indicated by the NW is regarded as “ON.” In this case, NCR executes the transfer of the cell-specific PDSCH indicated by the NW. Note that, in this case, a cell-specific PDSCH resource that is not indicated by the NW may be regarded as “OFF.” Further, NCR need not perform the transfer of the cell-specific PDSCH that is not indicated by the NW.

Note that, alternatively, the resource of the cell-specific PDSCH indicated by the NW may be regarded “OFF.” In this case, NCR need not perform the transfer of the cell-specific PDSCH indicated by the NW. Further, in this case, a cell-specific PDSCH resource that is not indicated by the NW may be regarded as “ON.” NCR may perform transfer of the cell-specific PDSCH that is not indicated by the NW.

Note that the method in which the NW indicates a cell-specific PDSCH resource is not limited.

### <Option 3 of Proposal 3-4>

In Option 3 of Proposal 3-4, the NW may indicate a set of cell-specific PDCCHs. The set of cell-specific PDCCHs indicated includes an indication of one or more cell-specific PDCCHs or resources for cell-specific PDCCHs. The resource of the cell-specific PDSCH scheduled by the cell-specific PDCCH indicated by the NW is regarded as “ON.” In this case, NCR executes transfer of the cell-specific PDSCH scheduled by the cell-specific PDCCH indicated by the NW.

Alternatively, the resource of the cell-specific PDSCH that is scheduled by the cell-specific PDCCH indicated by the NW is regarded as “OFF.” Then, in this case, NCR need not perform the transfer of the cell-specific PDSCH that is scheduled by the cell-specific PDCCH indicated by the NW.

Note that, the method for indicating a cell-specific PDCCH in Option 3 of Proposal 3-4 is not particularly limited. For example, a cell-specific PDCCH may be indicated by any of Options 2-1 to 2-5 of Proposal 3-3 described above.

In Proposal 3 above, NCR controls ON-ON based on the indication of the resources to be transferred (or the resources that need not be transferred) in a case where at least some of the resources of specific signals (or specific channels) are transferred. Thus, NCR can determine whether transfer is necessary, and perform transfer based on the determination, thereby realizing appropriate ON-OFF control of NCR. Further, it is possible to turn NCR OFF when transfer is not performed, thereby reducing power consumption and reducing interference with the surroundings.

### <Proposal 4>

In Proposal 3, the operation of indicating signals that needs to be transferred by NCR and regarding the resources of these indicated signals for NCR-MT as “ON” of NCR-Fwd has been described. Further, in Proposal 3, an SSB, CSI-RS, PDSCH, and PDCCH, which are possibly directly transmitted from a gNB to a UE, are exemplified as signals to be indicated. In Proposal 4, an RACH resource will be described as an example. Note that, in Proposal 4, the RACH resource is an example of a signal that is possibly directly transmitted from a UE to a gNB.

One option for the ON-OFF control of NCR-Fwd is that the resource of a cell-specific signal configured for NCR-MT is regarded as “ON” of NCR-Fwd. This is because the cell-specific signal is a signal also necessary for a normal UE and needs to be transferred between the normal UE and the gNB. Here, the normal UE may be, for example, a UE that is not an NCR (a UE that does not have a function as an NCR).

In the case of RACHs, however, it is conceivable that only some of RACH resources are transferred by NCR, and the remaining RACH resources are directly transmitted from the UE to the gNB without being transferred by NCR. The RACH resources that do not require to be transferred by NCR may be regarded as “OFF.” In other words, the RACH resources directly transmitted from the UE to the gNB are resources that do not require to be transferred, and thus NCR may turn NCR-Fwd “OFF” for the resource of a signal that does not require to be transferred from the UE to the gNB.

However, there is a possibility that NCR cannot determine whether the RACH resource is a RACH resource that needs to be transferred or a RACH resource that does not need to be transferred. In this case, for example, in a case where NCR-Fwd is turned ON to perform transfer for the RACH resource that does not need to be transferred, the power consumption in the NCR increases due to the unnecessary transfer. Further, interference is possibly caused by performing unnecessary transfer.

Further, for example, in a case where NCR-Fwd is not turned ON (the OFF state is maintained) for a RACH resource to be transferred, the communication quality between gNB and UE possibly deteriorates due to the RACH resource to be transferred not being transferred.

Thus, in Proposal 4, an operation is described in which a RACH resource that needs to be transferred by NCR is indicated, and the indicated RACH resource for NCR-MT is regarded as “ON” of NCR-Fwd. Next, a method for indicating a RACH that needs to be transferred by NCR will be described.

Note that, in the above, the control of “ON” or “OFF” of NCR-Fwd for the RACH resource has been described, but the present disclosure is not limited thereto. Not only the RACH resource, but also an SRS resource possibly causes the same problem as the RACH resource. In this case, NCR-Fwd performs the transfer of some of the SRS resources of NCR-MT in the same manner as in the example described above for the SRS resource. NCR-Fwd executing the transfer is regarded as NCR-Fwd being “ON.” Note that, in this case, NCR-Fwd does not need to perform the transfer of the remaining SRS resources of NCR-MT when performing the transfer of some of the SRS resources of NCR-MT, as in the example described above for RACH resources. NCR-Fwd not performing the transfer may be regarded as NCR-Fwd being “OFF.”

Hereinafter, each of the RACH resource and the SRS resource will be described.

### <Proposal 4-1>

In Proposal 4-1, an example of the relationship between a RACH resource (for example, a resource of a RACH occasion) and ON-OFF control of NCR-Fwd is described. For example, in Proposal 4-1, the resource of the RACH occasion of NCR-MT is regarded as “ON.” In other words, in Proposal 4-1, NCR-Fwd is turned “ON” for the resource of the RACH occasion of NCR-MT.

For example, the following options are described for a resource regarded as “ON.”

### <Option 1 of Proposal 4-1>

In Option 1 of Proposal 4-1, all resources of RACH occasions are regarded as “ON.” The all resources of RACH occasions may be, for example, all resources of RACH occasions of NCR-MT. In this case, NCR executes transfer for all RACH occasions. The transfer may be executed by NCR-Fwd.

Option 1 of Proposal 4-1 may be configured by an NW (for example, gNB) or may be enabled by an NW (for example, gNB), for example. In a case of being configured by the NW or enabled by the NW, all RACH occasion resources are regarded as “ON.” In this case, NCR executes the transfer for all RACH occasions.

### <Option 2 of Proposal 4-1>

In Option 2 of Proposal 4-1, the NW indicates a set of RACH occasions. The set of RACH occasions indicated includes an indication of one or more RACH occasions or resources of RACH occasions. The resource of the RACH occasion indicated by the NW is regarded as “ON.” In this case, NCR executes the transfer of the RACH occasion indicated by the NW. Note that, in this case, a resource of a RACH occasion that is not indicated by the NW may be regarded as “OFF.” NCR need not perform the transfer of the RACH occasion that is not indicated by the NW.

Alternatively, the resource of the RACH occasion indicated by the NW may be regarded as “OFF.” In this case, NCR need not perform the transfer of the RACH occasion indicated by the NW. Further, in this case, a resource of a RACH occasion that is not indicated by the NW may be regarded as “ON.” NCR may perform the transfer of the RACH occasion that is not indicated by the NW.

Note that the method in which the NW indicates a RACH occasion is not limited. For example, a method such as the following Option 2-1 or Option 2-2 may be applied.

### <Option 2-1 of Proposal 4-1>

In Option 2-1 of Proposal 4-1, the sequence of RACH occasion indices is indicated by the NW. For example, the indication of this sequence may be performed by the side control information. For example, the indication of this sequence may be performed by at least one of RRC, MAC CE, and DCI.

### <Option 2-2 of Proposal 4-1>

In Option 2-2 of Proposal 4-1, the bitmap of RACH occasions is indicated by the NW. For example, the indication of this bitmap may be performed by the side control information. For example, the indication of this bitmap may be performed by at least one of RRC, MAC CE, and DCI.

For example, each bit of the bitmap may correspond to one RACH occasion. For example, in a case where the bit of the bitmap is set to “0,” the SSB corresponding to the bit may be regarded as “ON.” In this case, NCR may execute the transfer of the SSB corresponding to the bit set to “0.” On the other hand, for example, in a case where the bit of the bitmap is set to “1,” the RACH occasion corresponding to the bit may be regarded as “OFF.” In this case, NCR need not execute the transfer of the RACH occasion corresponding to the bit set to “1.”

Note that the relationship between “0” and “1” of the bit and “ON” and “OFF” for the RACH occasion corresponding to the bit may be interchanged.

Note that each bit of the bitmap may correspond to a group of RACH occasions. Here, the group of RACH occasions may include one or more RACH occasions. The method of grouping RACH occasions is not particularly limited. The grouping of RACH occasions may be, for example, predefined or configured.

For example, one group of RACH occasions may include N RACH occasions (N is an integer of 1 or more). Further, RACH occasions with RACH occasion indices #0 to #N−1 may be included in the first group. Similarly, RACH occasions with RACH occasion indices #N to #2N−1 may be included in the second group. Similarly, RACH occasions with RACH occasion indices #kN to #kN+N−1 (k is an integer of 0 or more) may be included in the (k+1)th group.

### <Option 3 of Proposal 4-1>

In Option 3 of Proposal 4-1, the NW indicates a set of SSBs and/or CSI-RSs. The resource of a RACH occasion associated with the SSB and/or the CSI-RS indicated by the NW is regarded as “ON.” In this case, NCR performs the transfer of the RACH occasion associated with the SSB and/or CSI-RS indicated by the NW.

Note that, alternatively, the resource of the RACH occasion associated with the SSB and/or CSI-RS indicated by the NW may be regarded as “OFF.” In this case, NCR need not perform the transfer of the RACH occasion associated with the SSB and/or CSI-RS indicated by the NW. Further, in this case, a resource of a RACH occasion associated with an SSB and/or a CSI-RS that is not indicated by the NW may be regarded as “ON.” NCR may perform the transfer of the RACH occasion associated with the SSB and/or CSI-RS that is not indicated by the NW.

Note that the method for indicating an SSB and/or CSI-RS is not particularly limited. For example, the indication may be performed based on Option 2-1 or 2-2 of Proposal 3-1 or 3-2 described above.

### <Proposal 4-2>

In Proposal 4-2, an example of the relationship between an SRS resource transmitted by NCR-MT and ON-OFF control of NCR-Fwd will be described. For example, in Proposal 4-2, the SRS resource transmitted by NCR-MT is regarded as “ON.” In other words, in Proposal 4-2, NCR-Fwd is turned “ON” for the SRS resource transmitted by NCR-MT.

For example, Proposal 4-2 may be applied only to a periodic SRS. In other words, Proposal 4-2 need not be applied to an SRS that is not a periodic SRS.

Further, Proposal 4-2 may be applied only to a semi-persistent SRS. Further, Proposal 4-2 may be applied only to both a periodic SRS and a semi-persistent SRS.

Further, Proposal 4-2 may be applied only to an SRS configured for use in beam management and/or codebook and/or non-codebook and/or antenna switching.

For example, the following options are described for a resource regarded as “ON.”

### <Option 1 of Proposal 4-2>

In Option 1 of Proposal 4-2, all sets of SRS resources or SRS resources are regarded as “ON.” The all sets of SRS resources or SRS resource may be, for example, all of the sets of SRS resources or SRS resources transmitted by NCR-MT. In this case, NCR executes transfer for all SRSs. The transfer may be executed by NCR-Fwd.

For example, Option 1 of Proposal 4-2 may be configured by an NW (for example, gNB) or may be enabled by an NW (for example, gNB). In a case of being configured by the NW or enabled by the NW, all SRS resources are regarded as “ON.” In this case, NCR executes the transfer for all SRS resources.

### <Option 2 of Proposal 4-2>

In Option 2 of Proposal 4-2, the NW indicates a set of SRS resources or a set consisting of sets of SRS resources. The indicated set of SRS resources may include one or more SRS resources. Further, the indicated set consisting of sets of SRS resources may include at least one set of SRS resources.

The SRS resource or set of SRS resources indicated by the NW is regarded as “ON.” In this case, NCR executes the transfer of the SRS (for example, the SRS resource or set of SRS resources) indicated by the NW. Note that, in this case, an SRS resource or a set of SRS resources that is not indicated by the NW may be regarded as “OFF.” NCR need not perform the transfer of the SRS that is not indicated by the NW.

Alternatively, the SRS resource or the set of SRS resources indicated by the NW may be regarded as “OFF.” In this case, NCR need not execute the transfer of the SRS indicated by the NW. Further, in this case, an SRS resource or a set of SRS resources that is not indicated by the NW may be regarded as “ON.” NCR may perform the transfer of the SRS that is not indicated by the NW.

Note that the method in which the NW indicates an SRS resource or a set of SRS resources is not limited. For example, a method such as the following Option 2-1 or Option 2-2 may be applied.

### <Option 2-1 of Proposal 4-2>

In Option 2-1 of Proposal 4-2, a sequence of one or more SRS resource indices is indicated by the NW. Alternatively, a sequence of indices of one or more sets of SRS resources is indicated by the NW. For example, the indication of this sequence may be performed by the side control information. For example, the indication of this sequence may be performed by at least one of RRC, MAC CE, and DCI.

### <Option 2-2 of Proposal 4-2>

In Option 2-2 of Proposal 4-2, a bitmap of SRS resources or a set of SRS resources is indicated by the NW. For example, the indication of this bitmap may be performed by the side control information. For example, the indication of this bitmap may be performed by at least one of RRC, MAC CE, and DCI.

For example, each bit of the bitmap indicated by the NW may correspond to one SRS resource or one set of SRS resources. For example, in a case where the bit of the bitmap is set to “0,” the SRS resource or the set of SRS resources corresponding to the bit may be regarded as “ON.” Then, in this case, NCR may execute the transfer of the SRS corresponding to the bit set to “0.” On the other hand, for example, in a case where the bit of the bitmap is set to “1,” the SRS resource or the set of SRS resources corresponding to the bit may be regarded as “OFF.” In this case, NCR need not execute the transfer of the SRS corresponding to the bit set to “1.”

Note that the relationship between “0” and “1” of the bit and “ON” and “OFF” for the SRS resource or the set of SRS resources corresponding to the bit may be interchanged.

Note that any of the following variations may be applied to Option 2-2 of Proposal 4-2.

### <Variation 1>

The NW may indicate one set of SRS resources. Further, the bitmap may correspond to SRS resources included in the one set of SRS resources. This bitmap may be indicated by, for example, the NW.

### <Variation 2>

The NW may indicate a plurality of sets of SRS resources. Further, the bitmap may correspond to SRS resources included in the plurality sets of SRS resources. This bitmap may be indicated by, for example, the NW.

### <Variation 3>

The bitmap may correspond to SRS resources included in all sets of SRS resources.

### <Variation 4>

Each bit of the bitmap may correspond to a group of SRS resources. Alternatively, each bit of the bitmap may correspond to a group of sets of SRS resources. Here, the group of SRS resources may include one or more SRS resources. Further, the group of sets of SRS resources may include one or more sets of SRS resources. The method of grouping is not particularly limited. The grouping of SRS resources or sets of SRS resources may be, for example, predefined or configured.

For example, one group of SRS resources may include N SRS resources (N is an integer of 1 or more). Then, SRS resources corresponding to the lower N indices (for example, #0 to #N−1) of the SRS resource may be included in the first group. Similarly, SRS resources corresponding to the second lower N indices (for example, #N to #2N−1) of the SRSs may be included in the second group.

In Proposal 4 above, NCR controls ON-ON based on the indication of the resource to be transferred (or the resource that need not be transferred) in a case where at least some of the resources for specific signals (or specific channels) are transferred. Thus, NCR can determine whether transfer is necessary, and perform transfer based on the determination, thereby realizing appropriate ON-OFF control of NCR. Further, it is possible to turn NCR OFF when transfer is not performed, thereby reducing power consumption and reducing interference with the surroundings.

### <Capability of NCR>

In NCR, a capability (for example, capability information) may be defined. The capability defined for the NCR may be the same as or different from the capability defined for the UE. For example, the capabilities defined for the NCR may include at least one or some of the capabilities defined for the UE. Further, the capabilities defined for the UE may include at least one or some of the capabilities defined for the NCR. Further, at least one or some of the capabilities defined for the UE may implicitly or explicitly indicate at least one or some of the capabilities defined for the NCR.

For example, the following capabilities may be defined for NCR.
Whether ON-OFF control of NCR-Fwd is supported
Whether simultaneous operation in NCR is supported
Whether a specific signal is regarded as “ON” (or “OFF”)
Whether NCR-Fwd transfers a specific signal
Whether the operation described in each of the above proposals is possible.

For example, each of the above-described proposals may be applied in a case where the function corresponding to the proposal is supported by NCR and/or in a case where the function corresponding to the proposal is activated by a parameter of a higher layer.

Note that, in the above-described embodiment, turning “ON” may be read as being active, valid, enabled, activated, or the like, and turning “OFF” may be read as being inactive, invalid, disabled, sleep, or the like. The term “signal” may be read as information, control information, indication, or the like.

### (Apparatus Configuration)

Next, an exemplary functional configuration of base station 100 and terminal 200 that execute the processing and operations described so far will be described. Base station 100 and terminal 200 may have functions for implementing the embodiment described above. Note that base station 100 and terminal 200 may each have only some of the functions described in the embodiment.

### <Base Station>

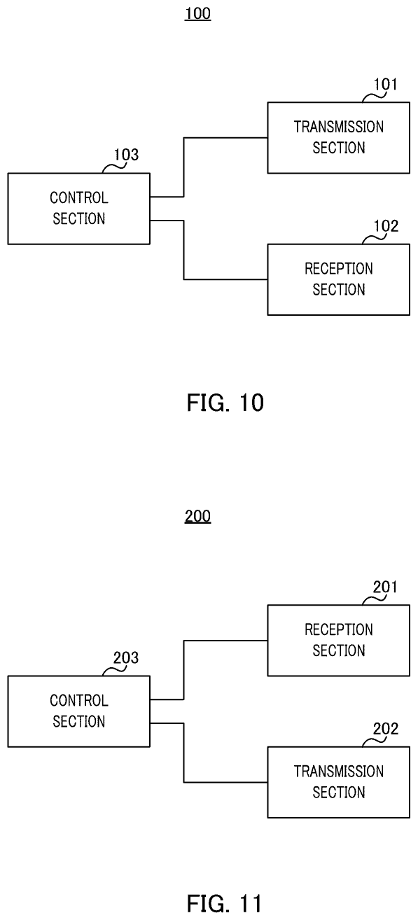

FIG. 10 is a block diagram illustrating an exemplary configuration of base station 100 according to an embodiment of the present disclosure. The base station includes, for example, transmission section 101, reception section 102, and control section 103. Base station 100 communicates with terminal 200 (see FIG. 18) by radio. Note that, transmission section 101 and reception section 102 may be collectively referred to as a communication section.

Transmission section 101 transmits the DL signal to terminal 200. For example, transmission section 101 transmits a DL signal under the control of control section 103. For example, the DL signal may include information indicating scheduling related to signal transmission of terminal 200 (for example, UL grant), control information of a higher layer, and the like.

For example, transmission section 101 transmits various control signals (such as control signals in the RRC layer), reference signals, data signals, and the like as DL signals to terminal 200. Transmission section 101 transmits, for example, various signals, channels, configuration information, control information, and the like described in the above embodiment to terminal 200 as DL signals.

For example, transmission section 101 transmits information on adaptation generated by control section 103 to terminal 200. Further, transmission section 101 transmits the data signal (for example, signal of XR traffic) generated by control section 103 to terminal 200.

Reception section 102 receives a UL signal transmitted from terminal 200. For example, reception section 102 receives a UL signal under the control of control section 103.

For example, reception section 102 receives, as a UL signal, a signal including terminal capability information (for example, UE capability) of terminal 200, various control signals, reference signals, data signals, and the like from terminal 200.

Control section 103 controls the overall (communication) operation of base station 100, including the transmission processing in transmission section 101 and the reception processing in reception section 102.

For example, control section 103 acquires information such as data and control information from a higher layer and outputs the information to transmission section 101. Further, control section 103 outputs the data and control information received from reception section 102 to a higher layer.

For example, control section 103 allocates resources for the transmission and reception of DL signals and/or resources for the transmission and reception of UL signals based on signals (for example, data, control information, and the like) received from terminal 200 and/or data and control information acquired from a higher layer. Information on the allocated resource may be included in control information to be transmitted to terminal 200.

Control section 103 executes operations other than the transmission and reception described in the above embodiment (the operations may be executed by transmission section 101 and/or reception section 102).

For example, control section 103 determines whether to apply adaptation and, in the case of applying adaptation, determines the on period during which adaptation is applied. Control section 103 generates information on adaptation to be transmitted to terminal 200 based on the determination result. Further, for example, control section 103 determines an element to be adapted (for example, a parameter to be adjusted (at least one of the start position, the end position, and the length of the on period)) and determines the amount of adjustment of the determined parameter. Control section 103 may generate information including the determined content as control information.

### <Terminal>

FIG. 11 is a block diagram illustrating an exemplary configuration of terminal 200 according to an embodiment of the present disclosure. Terminal 200 includes, for example, reception section 201, transmission section 202, and control section 203. Terminal 200 communicates with, for example, base station 100 (see FIG. 17) by radio. Note that, reception section 201 and transmission section 202 may be collectively referred to as a communication section.

Reception section 201 receives a DL signal transmitted from base station 100. For example, under the control of control section 203, reception section 201 receives a DL signal.

For example, reception section 201 receives various control signals, reference signals, data signals, and the like from base station 100 as DL signals. Reception section 201 receives, for example, various signals, channels, configuration information, control information, and the like described in the above embodiment as DL signals from base station 100.

For example, reception section 201 receives a signal from base station 100 during the on period. The signal to be received may include information on adaptation. Further, the signal to be received may include a signal of XR traffic.

Transmission section 202 transmits a UL signal to base station 100. For example, transmission section 202 transmits a UL signal under the control of control section 203.

For example, transmission section 202 transmits, as a UL signal, a signal including information on the processing capability of terminal 200, various control signals, reference signals, data signals, and the like to base station 100.

Control section 203 controls the overall (communication) operation of terminal 200, including the reception processing in reception section 201 and the transmission processing in transmission section 202.

For example, control section 203 acquires information such as data and control information from a higher layer and outputs the information to transmission section 202. Further, control section 203 outputs, for example, data and control information received from reception section 201 to a higher layer.

For example, control section 203 applies Adaptation in the on period based on the information related to the received adaptation and/or the information defined in advance. Note that the on period to which the Adaptation is applied may be determined based on information related to the received adaptation or may be determined based on a predetermined condition. Further, for example, control section 103 determines an element to be adapted (for example, a parameter to be adjusted (at least one of the start position, the end position, and the length of the on period)) based on a predetermined condition and/or the received information, and determines the amount of adjustment of the determined parameter. Control section 103 applies adaptation based on the determined content.

Control section 203 executes operations other than the transmission and reception described in the above embodiment (note that the operations may be executed by reception section 201 and/or transmission section 202).

### <Relay Apparatus>

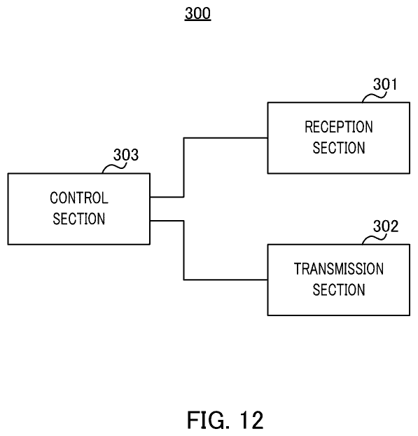

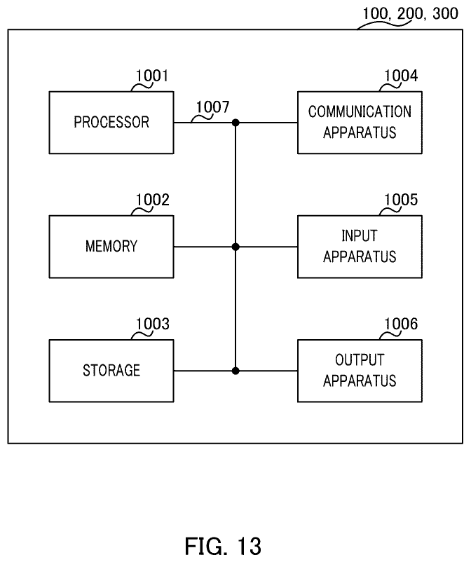

FIG. 12 is a block diagram illustrating an exemplary configuration of relay apparatus 300 according to the embodiment of the present disclosure. Relay apparatus 300 corresponds to an example of NCR. Relay apparatus 300 includes, for example, reception section 301, transmission section 302, and control section 303. Relay apparatus 300 communicates with, for example, base station 100 (see FIG. 10) and terminal 200 (see FIG. 11) by radio. Note that, reception section 301 and transmission section 302 may be collectively referred to as a communication section.

Reception section 301 receives a DL signal transmitted from base station 100. Further, reception section 301 receives a UL signal transmitted from terminal 200. For example, reception section 301 receives a DL signal and a UL signal under the control of control section 303. Note that the signal to be received may include a signal addressed to base station 100, a signal addressed to terminal 200, and a signal addressed to relay apparatus 300.

Transmission section 302 transmits the UL signal which is received from terminal 200 and is addressed to base station 100, to base station 100. Further, transmission section 302 transmits the DL signal which is received from base station 100 and is addressed to terminal 200, to terminal 200. For example, transmission section 302 transmits the UL signal under the control of control section 303.

Control section 303 controls the overall (communication) operation of relay apparatus 300, including the reception processing in reception section 301 and the transmission processing in transmission section 302.

For example, control section 303 acquires information such as data and control information from a higher layer and outputs the information to transmission section 302. Further, control section 303 outputs, for example, data and control information received from reception section 301 to a higher layer.

Control section 303 executes operations other than the transmission and reception described in the above embodiment (note that the operations may be executed by reception section 301 and/or transmission section 302).

Further, in FIG. 12, a configuration is illustrated in which one of each of reception section 301, transmission section 302, and control section 303 is included, but the present disclosure is not limited thereto. For example, as described above, relay apparatus 300 (for example, NCR 300) includes two functional entities: NCR-MT, which performs communication in the C-link; and NCR-Fwd, which performs communication in the access link and the backhaul link. Therefore, relay apparatus 300 may include a reception section, a transmission section, and a control section for each of NCR-MT and NCR-Fwd. Further, relay apparatus 300 may include a reception section, a transmission section, and a control section for each communication of the C-link, the access link, and the backhaul link.

Note that relay apparatus 300 (for example, NCR) in the present disclosure may be an example of a communication apparatus. Further, relay apparatus 300 in the present disclosure may be referred to by another name such as a transfer apparatus. Further, relay apparatus 300 in the present disclosure may be replaced with terminal 200 (for example, UE). For example, relay apparatus 300 may be regarded as terminal 200 having a transfer function (or a relay function).

### (Summary of Embodiment)

According to an embodiment of the present disclosure, a communication apparatus is provided, including: a control section that controls, based on whether a simultaneous operation of a transmission operation or a reception operation in a first link between a base station and the communication apparatus and a transmission operation or a reception operation in a second link between the base station and the communication apparatus is supported, the transmission operation or the reception operation in the second link, the second link being used for transfer between the base station and a terminal; and a communication section that performs transmission or reception of a signal in the second link in accordance with the control by the control section.

With the above configuration, it is possible to control the operation in the second link based on whether the communication apparatus supports the simultaneous operation of the operation in the first link (for example, C-link) and the operation in the second link (for example, backhaul link and/or access link). Therefore, it is possible to perform appropriate control of the relay operation (for example, ON-OFF control of NCR-Fwd) in the second link depending on the presence or absence of support for the simultaneous operation.

In the present communication apparatus, in a case where the simultaneous operation of the transmission operation in the first link and the transmission operation in the second link is not supported, the control section performs control such that a transmission operation is performed in one of the first link and the second link and a transmission operation is not performed in the other.

With the above configuration, in a case the simultaneous operation of the transmission operation in the first link and the transmission operation in the second link is not supported, it is possible to control the both operations not to operate, thereby enabling appropriate control of the relay operation (for example, ON-OFF control of NCR-Fwd) depending on the presence or absence of support for simultaneous operation.

In the present communication apparatus, in a case where the simultaneous operation of the reception operation in the first link and the reception operation in the second link is not supported, the control section performs control such that a reception operation is performed in one of the first link and the second link and a reception operation is not performed in the other.

With the above configuration, in a case where the simultaneous operation of the reception operation in the first link and the reception operation in the second link is not supported, it is possible to control the both operations not to operate, and thus, thereby enabling appropriate control of the relay operation (for example, ON-OFF control of NCR-Fwd) depending on the presence or absence of support for simultaneous operation.

In the present communication apparatus, in a case where the simultaneous operation of the transmission operation in the first link and the transmission operation in the second link is supported, the control section controls the transmission operation in the second link based on an indication related to the transmission operation in the first link.

With the above configuration, in a case where the simultaneous operation of the transmission operation in the first link and the transmission operation in the second link is supported, it is possible to perform control that allows both operations, and thus, it is possible to perform appropriate control of the relay operation (for example, ON-OFF control of NCR-Fwd) depending on the presence or absence of the support for the simultaneous operation. Further, in a case where the simultaneous operation is supported, based on an indication related to one operation, the other operation can be controlled, thereby reducing signaling overhead.

In the communication apparatus, in a case where the simultaneous operation of the reception operation in the first link and the reception operation in the second link is supported, the control section controls the reception operation in the second link based on an indication related to the reception operation in the first link.

With the above configuration, in a case where the simultaneous operation of the reception operation in the first link and the reception operation in the second link is supported, it is possible to perform control that allows both operations, and thus, it is possible to perform appropriate control (for example, ON-OFF control of NCR-Fwd) depending on the presence or absence of the support for the simultaneous operation. Further, in a case where the simultaneous operation is supported, based on an indication related to one operation, the other operation can be controlled, thereby reducing signaling overhead.

According to an embodiment of the present disclosure, a communication method is provided in which a communication apparatus controls, based on whether a simultaneous operation of a transmission operation or a reception operation in a first link between a base station and the communication apparatus and a transmission operation or a reception operation in a second link between the base station and the communication apparatus is supported, the transmission operation or the reception operation in the second link, the second link being used for transfer between the base station and a terminal, and performs transmission or reception of a signal in the second link in accordance with the control.

With the above configuration, it is possible to control the operation in the second link based on whether the communication apparatus supports the simultaneous operation of the operation in the first link (for example, C-link) and the operation in the second link (for example, backhaul link and/or access link). Therefore, it is possible to perform appropriate control (for example, ON-OFF control of NCR-Fwd) in the second link depending on the presence or absence of support for the simultaneous operation.

According to an embodiment of the present disclosure, a communication apparatus is provided, including: a control section that controls, based on a resource configured in a first link between a base station and the communication apparatus, a transfer operation in a second link used for transfer between the base station and a terminal through the communication apparatus; and a communication section that performs transfer of a signal in the second link in accordance with the control of the control section.

With the above configuration, it is possible to control the transfer operation based on the resource configured in the first link, thus enabling appropriate control of the relay operation (for example, ON-OFF control of NCR-Fwd) depending on the necessity of transfer indicated by the resource configured in the first link.

In the present communication apparatus, the control section performs the transfer operation in the second link in a case where the resource configured in the first link is a specific resource, and does not perform the transfer operation in the second link in a case where the resource configured in the first link is not the specific resource.

With the above configuration, it is possible to control the transfer operation based on the resource configured in the first link, and thus, in a case where the resource configured in the first link is a resource that requires to be transferred, it is possible to perform appropriate control of the relay operation (for example, ON-OFF control of NCR-Fwd).

In the present communication apparatus, the specific resource is a resource configured for each specific signal received in the configured resource.

With the above configuration, it is possible to control the transfer operation based on the resource configured in the first link, and thus, in a case where the resource configured in the first link is a resource that requires to be transferred, it is possible to perform appropriate control of the relay operation (for example, ON-OFF control of NCR-Fwd).

In the present communication apparatus, the specific signal is at least one of a Synchronization Signal Block (SSB) signal, a Channel State Information Reference Signal (CSI-RS), a cell-specific Physical Downlink Control Channel (PDCCH) signal, and a cell-specific Physical Downlink Shared Channel (PDSCH) signal.

With the above configuration, it is possible to perform appropriate control of the relay operation (for example, ON-OFF control of NCR-Fwd) in a case where the resource configured in the first link is a resource of at least one of an SSB signal, a CSI-RS, a cell-specific PDCCH signal, and a cell-specific PDSCH signal.

In the present communication apparatus, the specific resources is a resource indicated.

With the above configuration, it is possible to perform appropriate control of the relay operation (for example, ON-OFF control of NCR-Fwd) in a case where the resource configured in the first link is an indicated resource.

According to an embodiment of the present disclosure, a communication method is provided in which a communication apparatus controls, based on a resource configured in a first link between a base station and the communication apparatus, a transfer operation in a second link used for transfer between the base station and a terminal through the communication apparatus, and performs transfer of a signal in the second link in accordance with the control.

With the above configuration, it is possible to control the transfer operation based on the resource configured in the first link, thus enabling appropriate control of the relay operation (for example, ON-OFF control of NCR-Fwd) depending on the necessity of transfer indicated by the resource configured in the first link.

Note that relay apparatus 300 (for example, NCR) in the present disclosure may be read as a base station. In this case, base station 100 may have the functions described above that relay apparatus 300 has. Further, relay apparatus 300 (for example, NCR) in the present disclosure may be read as a terminal. In this case, terminal 200 may have the functions described above that relay apparatus 300 has.

The present disclosure has been described above. The division of the items in the above description is not essential to the present disclosure, and matters described in two or more items may be combined and used as necessary, and a matter described in one item may be applied to a matter described in another item (as long as the maters do not contradict each other).

### <Hardware Structure>

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

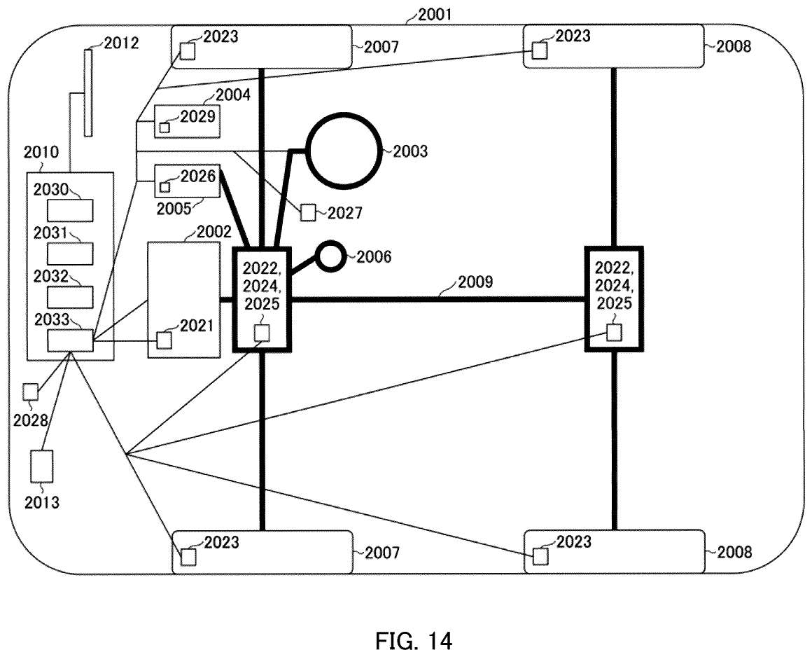

For example, a base station, a terminal, a relay apparatus (e.g., NCR), and so on according to one embodiment of the present disclosure may function as a computer that executes the processes of the radio communication method of the present disclosure. FIG. 13 is a diagram to show an example of a hardware structure of a base station, a terminal, and a relay apparatus according to one embodiment of a present disclosure. Physically, the above-described base station 100, terminal 200, and relay apparatus 300 may each be formed as a computer apparatus that includes processor 1001, memory 1002, storage 1003, communication apparatus 1004, input apparatus 1005, output apparatus 1006, bus 1007, and so on.

Note that in the present disclosure, the words such as an apparatus, a circuit, a device, a section, a unit, and so on can be interchangeably interpreted. The hardware structure of base station 100, terminal 200, and relay apparatus 300 may be configured to include one or more of apparatuses shown in the drawings, or may be configured not to include part of apparatuses

Each function of base station 100, terminals 200, and relay apparatus 300 is implemented, for example, by allowing certain software (programs) to be read on hardware such as processor 1001 and memory 1002, and by allowing processor 1001 to perform calculations to control communication via communication apparatus 1004 and control at least one of reading and writing of data in memory 1002 and storage 1003.

Processor 1001 controls the whole computer by, for example, running an operating system. Processor 1001 may be configured with a central processing unit (CPU), which includes interfaces with peripheral apparatus, control apparatus, computing apparatus, a register, and so on. For example, at least part of above-described control section 103 or control section 203, control section 303, and so on may be implemented by processor 1001.

Furthermore, processor 1001 reads programs (program codes), software modules, data, and so on from at least one of storage 1003 and communication apparatus 1004, into memory 1002, and executes various processes according to these. As for the programs, programs to allow computers to execute at least part of the operations of the above-described embodiments are used. For example, base station 100, terminal 200, and relay apparatus 300 may be implemented by control programs that are stored in memory 1002 and that operate on processor 1001, and other functional blocks may be implemented likewise. The various processes have been described to be performed by single processor 1001. However, the processes may be performed by two or more processors 1001 simultaneously or sequentially. Processor 1001 may be implemented by one or more chips. It should be noted that the program may be transmitted from a network via a telecommunication line.

Memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. Memory 1002 may be referred to as a “register,” a “cache,” a “main memory (primary storage apparatus)” and so on. Memory 1002 can store executable programs (program codes), software modules, and the like for implementing the radio communication method according to one embodiment of the present disclosure.

Storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. Storage 1003 may be referred to as “auxiliary storage apparatus.” The above recording medium may be a database including memory 1002 and/or storage 1003, a server, or any other appropriate medium.

Communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. Communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmission section 101, transmission section 202, transmission section 302, reception section 102, reception section 201, reception section 301, and the like, may be implemented realized by communication apparatus 1004. Communication apparatus 1004 may be implemented by physically or logically divided into a transmission section and reception section.

Input apparatus 1005 is an input device that receives input from the outside (for example, a keyboard, a mouse, a microphone, a switch, a button, a sensor, and so on). Output apparatus 1006 is an output device that allows sending output to the outside (for example, a display, a speaker, a Light Emitting Diode (LED) lamp, and so on). Note that input apparatus 1005 and output apparatus 1006 may be provided in an integrated structure (for example, a touch panel).

Furthermore, these types of apparatus, including processor 1001, memory 1002, and others, are connected by bus 1007 for communicating information. Bus 1007 may be formed with a single bus, or may be formed with buses that vary between pieces of apparatus.

Also, base station 100, terminals 200, and relay apparatus 300 may be structured to include hardware such as a microprocessor, a digital signal processor (DSP), an Application Specific Integrated Circuit (ASIC), a Programmable Logic Device (PLD), a Field

Programmable Gate Array (FPGA), and so on, and part or all of the functional blocks may be implemented by the hardware. For example, the processor 1001 may be implemented with at least one of these pieces of hardware.

### (Supplement to Embodiment)

While the embodiment of the present disclosure has been described above, the disclosed invention is not limited to such an embodiment, and a person skilled in the art would understand various variations, modifications, alternatives, substitutions, and the like. Specific numerical examples have been used in the description to facilitate understanding of the invention, but unless otherwise noted, these numbers are merely examples and any suitable values may be used. The division of the items in the above description is not essential to the present disclosure, and matters described in two or more items may be combined and used as necessary, and matters described in one item may be applied to matters described in another item (as long as they do not contradict each other). The boundaries of the functional sections and processing sections in the functional block diagram do not necessarily correspond to the boundaries of physical components. The operations of a plurality of functional sections may be performed physically by one component, or the operation of one functional section may be performed physically by a plurality of components. The processing procedures described in the embodiment may be performed in a different order as long as there is no contradiction. For convenience of description of the processing, base station 100, terminal 200, and relay apparatus 300 have been described using functional block diagrams, but such apparatuses may be implemented in hardware, software, or a combination thereof. Software that operates on a processor included in base station 100 according to an embodiment of the present disclosure, software that operates on a processor included in terminal 200 according to an embodiment of the present disclosure, and software that operates on a processor included in relay apparatus 300 according to an embodiment of the present disclosure may each be stored in any suitable storage medium, such as a random access memory (RAM), a flash memory, a read-only memory (ROM), an erasable programmable read-only memory (EPROM), an electrically erasable programmable read-only memory (EEPROM), a register, a hard disk (HDD), a removable disk, a CD-ROM, a database, a server, or the like.

### <Notification and Signaling of Information>

Notification of information is by no means limited to the embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

### <Application System>

The embodiments illustrated in the present disclosure may be applied to Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New Radio (NR), New radio access (NX), Future generation radio access (FX), W-CDMA (registered trademark), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) for application.

### <Processing Procedure and the Like>

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

### <Operation of Base Station>

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities

(MMEs), Serving-Gateways (S-GWs), and so on may be possible, but these are not limiting) other than base stations, or combinations of these. According to the above, a case is described in which there is a single network node other than the base station. However, a combination of multiple other network nodes may be considered (e.g., MME and S-GW).

### <Direction of Input and Output>

The information or signals described in this disclosure may be output from a higher layer (or lower layer) to a lower layer (or higher layer). The information or signals may be input or output through multiple network nodes.

### <Handling of Input and Output Information and the Like>

The input or output information may be stored in a specific location (e.g., memory) or managed using management tables. The input or output information may be overwritten, updated, or added. The information that has been output may be deleted. The information that has been input may be transmitted to another apparatus.

### <Determination Method>

A decision or a determination in an embodiment of the present invention may be realized by a value (0 or 1) represented by one bit, by a boolean value (true or false), or by comparison of numerical values (e.g., comparison with a predetermined values).

<Variations and the like of Aspects>

Each aspect/embodiment described in the present specification may be used independently, may be used in combination, or may be used by switching according to operations. Further, notification of predetermined information (e.g., notification of “X”) is not limited to an explicit notification, and may be performed by an implicit notification (e.g., by not performing notification of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### <Software>

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

### <Information and Signals>

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

### <System and Network>

As used in the present disclosure, the terms “system” and “network” are used interchangeably.

### <Names of Parameters and Channels>

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

### <Base Station>

In the present disclosure, the terms such as a “base station (BS),” a “radio base station,” a “fixed station,” a “NodeB,” an “eNB (eNodeB),” a “gNB (gNodeB),” an “access point,” a “transmission point,” a “reception point,” a “transmission/reception point,” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station

### <Mobile Station>

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

### <Base Station/Mobile Station>

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on. The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an

Internet of Things (IOT) device such as a sensor.

Furthermore, the base station in the present disclosure may be interpreted as a terminal. For example, an embodiment of the present disclosure may be applied to the structure that replaces a communication between a base station and a terminal with a communication between a plurality of terminals (for example, which may be referred to as

“Device-to-Device (D2D),” “Vehicle-to-Everything (V2X),” and the like). In this case, terminals 200 may have the functions of base stations 100 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the terminal in the present disclosure may be interpreted as base station. In this case, base station 100 may have the functions of terminal 200 described above.

FIG. 14 shows an example of a configuration of vehicle 2001. As shown in FIG. 14, vehicle 2001 includes drive unit 2002, steering unit 2003, accelerator pedal 2004, brake pedal 2005, shift lever 2006, front wheel 2007, rear wheel 2008, axle 2009, electronic control unit 2010, various sensors 2021 to 2029, information service unit 2012, and communication module 2013. The aspects/embodiments described in the present disclosure may be applied to a communication device mounted in vehicle 2001, and may be applied to, for example, communication module 2013.

Drive unit 2002 may include, for example, an engine, a motor, and a hybrid of an engine and a motor. Steering unit 2003 includes at least a steering wheel and is configured to steer at least one of the front wheel or the rear wheel, based on the operation of the steering wheel operated by the user.

Electronic control unit 2010 includes microprocessor 2031, memory (ROM, RAM) 2032, and communication port (IO port) 2033. Electronic control unit 2010 receives signals from the various sensors 2021 to 2029 provided in vehicle 2001. Electronic control unit 2010 may be referred to as an ECU (Electronic control unit).

Signals from various sensors 2021 to 2029 include a current signal from current sensor 2021 which senses the current of the motor, a front or rear wheel rotation signal acquired by revolution sensor 2022, a front or rear wheel pneumatic signal acquired by pneumatic sensor 2023, a vehicle speed signal acquired by vehicle speed sensor 2024, an acceleration signal acquired by acceleration sensor 2025, a stepped-on accelerator pedal signal acquired by accelerator pedal sensor 2029, a stepped-on brake pedal signal acquired by brake pedal sensor 2026, an operation signal of a shift lever acquired by shift lever sensor 2027, and a detection signal, acquired by object detection sensor 2028, for detecting an obstacle, a vehicle, a pedestrian, and the like.

Information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

Information service unit 2012 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

Driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, driving support system unit 2030 transmits and receives various types of information via communication module 2013 to realize a driving support function or an autonomous driving function.

Communication module 2013 may communicate with microprocessor 2031 and components of vehicle 2001 via a communication port. For example, communication module 2013 transmits and receives data via communication port 2033, to and from drive unit 2002, steering unit 2003, accelerator pedal 2004, brake pedal 2005, shift lever 2006, front wheel 2007, rear wheel 2008, axle 2009, microprocessor 2031 and memory (ROM, RAM) 2032 in electronic control unit 2010, and sensors 2021 to 2029 provided in vehicle 2001.

Communication module 2013 is a communication device that can be controlled by microprocessor 2031 of electronic control unit 2010 and that is capable of communicating with external devices. For example, various kinds of information are transmitted to and received from external devices through radio communication. Communication module 2013 may be internal to or external to electronic control unit 2010. The external devices may include, for example, a base station, a mobile station, or the like.

Communication module 2013 may transmit at least one of signals from various sensors 2021 to 2029 described above input to electronic control unit 2010, information obtained based on the signals, and information based on an input from the outside (a user) obtained via information service unit 2012, to the external apparatus via radio communication. Electronic control unit 2010, various sensors 2021 to 2029, information service unit 2012, and the like may be referred to as input units that receive input. For example, the PUSCH transmitted by communication module 2013 may include information based on the input.

Communication module 2013 receives various types of information (traffic information, signal information, inter-vehicle information, etc.) transmitted from the external devices and displays the received information on information service unit 2012 provided in vehicle 2001. Information service unit 2012 may be referred to as an output unit that outputs information (for example, outputs information to devices, such as a display and a speaker, based on the PDSCH received by communication module 2013 (or data/information decoded from the PDSCH)). In addition, communication module 2013 stores the various types of information received from the external devices in memory 2032 available to microprocessor 2031. Based on the information stored in memory 2032, microprocessor 2031 may control drive unit 2002, steering unit 2003, accelerator pedal 2004, brake pedal 2005, shift lever 2006, front wheel 2007, rear wheel 2008, axle 2009, sensors 2021 to 2029 etc., mounted in vehicle 2001.

### <Meaning and Interpretation of Terms>

As used herein, the term “determining” may encompasses a wide variety of actions. For example, “determining” may be regarded as judging, calculating, computing, processing, deriving, investigating, looking up or search inquiry (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing, and the like. That is, “determining” may be regarded as a certain type of action related to determining. Also, “determining” may be replaced with “assuming,” “expecting,” “considering,” and the like.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

### <Reference Signal>

A reference signal may be abbreviated as an “RS,” and may be referred to as a “pilot” and so on, depending on which standard applies.

### <Meaning of “Based On”>

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

### <“First” and “Second”>

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

### <Means>

“Means” included in the configuration of each of the above apparatuses may be replaced by “parts,” “circuits,” “devices,” etc.

### <Open Form>

In the case where the terms “include,” “including” and variations thereof are used in the present disclosure, these terms are intended to be comprehensive in the same way as the term “comprising.” Further, the term “or” used in the present specification is not intended to be an “exclusive or”.

<Time Units such as TTI, Frequency Units such as RB, and Radio Frame Configuration>

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a “Transmission Time Interval (TTI),” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in LTE Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP.”

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

### <Maximum Transmit Power>

The “maximum transmit power” described in the present disclosure may mean a maximum value of the transmit power, the nominal UE maximum transmit power, or the rated UE maximum transmit power.

### <Article>

In the present disclosure, where an article is added by translation, for example “a,” “an,” and “the,” the disclosure may include that the noun following these articles is plural.

### <“Different”>

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different.”

### INDUSTRIAL APPLICABILITY

An aspect of the present disclosure is useful for radio communication systems.

### REFERENCE SIGNS LIST

10 Radio communication system
20 NG-RAN
100 Base station (gNB)
200 Terminal (UE)
300 Relay apparatus (NCR)
101, 202, 302 Transmission section
102, 201, 301 Reception section
103, 203, 303 Control section
1001 Processor
1002 Memory
1003 Storage
1004 Communication apparatus
1005 Input apparatus
1006 Output apparatus
1007 Bus

1. A communication apparatus, comprising:
a control section that controls, based on whether a simultaneous operation of a transmission operation or a reception operation in a first link between a base station and the communication apparatus and a transmission operation or a reception operation in a second link between the base station and the communication apparatus is supported, the transmission operation or the reception operation in the second link, the second link being used for transfer between the base station and a terminal; and
a communication section that performs transmission or reception of a signal in the second link in accordance with the control by the control section.

2. The communication apparatus according to claim 1, wherein
in a case where the simultaneous operation of the transmission operation in the first link and the transmission operation in the second link is not supported, the control section performs control such that a transmission operation is performed in one of the first link and the second link and a transmission operation is not performed in the other.

3. The communication apparatus according to claim 1, wherein
in a case where the simultaneous operation of the reception operation in the first link and the reception operation in the second link is not supported, the control section performs control such that a reception operation is performed in one of the first link and the second link and a reception operation is not performed in the other.

4. The communication apparatus according to claim 1, wherein
in a case where the simultaneous operation of the transmission operation in the first link and the transmission operation in the second link is supported, the control section controls the transmission operation in the second link based on an indication related to the transmission operation in the first link.

5. The communication apparatus according to claim 1, wherein
in a case where the simultaneous operation of the reception operation in the first link and the reception operation in the second link is supported, the control section controls the reception operation in the second link based on an indication related to the reception operation in the first link.

6. A communication method, comprising:
controlling, by a communication apparatus, based on whether a simultaneous operation of a transmission operation or a reception operation in a first link between a base station and the communication apparatus and a transmission operation or a reception operation in a second link between the base station and the communication apparatus is supported, the transmission operation or the reception operation in the second link, the second link being used for transfer between the base station and a terminal; and
performing, by the communication apparatus, transmission or reception of a signal in the second link in accordance with the controlling.
